(19) United States
(12) Patent Application Publication
(10) Pub. No.: US 2023/0146134 A1
(43) Pub. Date: May 11, 2023

(54) OBJECT RECOGNITION VIA OBJECT DATA DATABASE AND AUGMENTATION OF 3D IMAGE DATA

(71) Applicant: CORREVATE LIMITED, London Greater, London (GB)

(72) Inventors: David SELVIAH, London, Greater London (GB); Liang CHENG, London, Greater London (GB); Roger MARAN, London, Greater London (GB)

(21) Appl. No.: 17/905,153

(22) PCT Filed: Feb. 12, 2021
(86) PCT No.: PCT/GB2021/050344

§ 371 Date: Aug. 26, 2022

(30) Foreign Application Priority Data
Feb. 28, 2020 (GB) 2002903.9

(51) Int. Cl. G06V 20/64; G06V 10/75; G06T 19/00; G06V 10/26; G06V 10/764; G06V 10/44; G06V 20/70

(52) U.S. Cl. CPC G06V 20/653; G06V 10/7515; G06V 10/757; G06T 19/006; G06V 10/26; G06V 10/764; G06V 10/44; G06V 20/70; G06T 2219/004

(57) ABSTRACT

Embodiments provide an image processing method, program, and apparatus, for using a database of data manifestations of objects to identify those objects in image data representing a domain or space containing objects to be identified. Embodiments leverage 3D vector field representations of both the domain or space, and of the objects, to perform the recognition. Embodiments annotate the image data with information relating to the identified objects, and/or replace portions of the image data with a data manifestation of the recognised object imported from the database.

### TECHNICAL FIELD

Embodiments lie in the field of image processing. In particular, embodiments relate to object recognition in image data, and augmentation of image data using the results of object recognition.

Engineers and technicians operating in a physical domain may require knowledge of the objects present in said physical domain. For example, an engineer working on a section of railway track may wish to know which transponders and signal boxes are present in the vicinity of the track. An engineer, or any technician, working on a building may wish to identify the contents of the building.

Image data representing the domain may be processed on screen by a trained operator in order to identify objects present in the domain, but this process is time-consuming and inconvenient, and is limited by domain knowledge of the operator, and may suffer from mistakes in mislabelling objects or the positions and orientations of objects. Presently available automated techniques are too time consuming to be practical, and suffer from inaccuracy.

It is desirable to provide a method for processing 3D image data representing a physical domain to automatically recognise the objects present in the physical domain and augment the 3D image data with the results of the recognition.

### BACKGROUND AND SUMMARY

Embodiments include an image processing method comprising: obtaining image data, the image data comprising readings providing a 3D representation of a domain; converting the image data to a domain 3D vector field consisting of vectors representing the readings as vectors by deriving information from the readings in the image data and using a defined information-to-vector transform to convert the derived information into vectors, each of the vectors being positioned (and optionally, in some examples, oriented) in the domain 3D vector field in accordance with positions (and optionally, in some examples, orientations) of the readings represented by the respective vector in the image data; access an object data database wherein each of a plurality of candidate objects is, in a first representation, stored in a predetermined format and/or stored as object metadata, and in a second representation, stored as a object 3D vector field having been derived from a transform corresponding to the defined information-to-vector transform; compare the domain 3D vector field with the object 3D vector field; wherein the comparing comprises finding at least one maximum, by relative rotation of the vectors of the domain 3D vector field with respect to the vectors of the object 3D vector field with the vectors positioned (and optionally, in some examples, oriented) at a common origin, of a degree of match between the vectors of the domain 3D vector field and the vectors of the object 3D vector field, for the or each of the at least one maximum, based on the degree of match, determining whether or not the respective candidate object is present in the physical imaged domain, and for instances in which it is determined that the respective candidate object is present in the imaged domain: placing the predetermined format data representation of the respective candidate object in the obtained image data at an orientation determined by the relative rotation of the two sets of vectors providing the at least one maximum degree of match; and/or annotating the obtained image data with the metadata of the candidate object determined to be present in the imaged domain. In some examples, the maximum may comprise a local maximum.

Therefore, in some embodiments, each of a plurality of candidate objects is, in a first representation, in a predetermined format, together with object metadata, and in a second representation, stored as an object 3D vector field having been derived from a transform corresponding to the defined information-to-vector transform; compare the domain 3D vector field with the object 3D vector field, and the method comprises either placing the predetermined format data representation of the respective candidate object in the obtained image data at an orientation determined by the relative rotation of the two sets of vectors providing the at least one maximum degree of match; or annotating the obtained image data with the metadata of the candidate object determined to be present in the imaged domain.

In some examples, determining whether or not the respective candidate object is present in the physical imaged domain, for the or each of the at least one maximum, based on the degree of match, comprises comparing the magnitude of the maximum with a threshold value, where local maxima with magnitudes higher than the threshold may indicate that the object is in the domain. The threshold value may be determined by prior experimentation with similar datasets or calculation based on overlap or correlation and point density. One example calculation of correlation is to find the normalised correlation which is [domain correlated with object]/[Square root of (domain correlated with domain)×square root of (object correlated with object)] either for the whole domain or for just the part overlapping with the object.

The image data may be obtained from a 3D scanner, may be composed of 2D images, or, in either case, may be read from storage. The image data may be a point cloud representation of a domain. The method may be implemented by a computer or plurality of computers cooperating in a network. The object data database may be stored by the one or more computers executing the method, or by a data centre or other data storage apparatus accessible to said computer.

Embodiments provide a computationally efficient method to recognise objects in image data and to augment the image data with the results of the object recognition (by annotation or replacement).

In particular, the domain 3D vector field may comprise a plurality of sub-fields, and the comparing may comprise comparing each of the plurality of sub-fields with the object 3D vector field of each of the plurality of candidate objects; wherein the comparing includes dividing the 3D representation of the domain into a plurality of sub-divisions, and each sub-field corresponds to a respective one of the sub-divisions; or wherein the sub fields are individual or groups of features extracted from the domain 3D vector field by a segmentation algorithm.

Optionally, each of the plurality of sub fields is assigned to a distinct processor apparatus, and the plurality of sub fields are compared in parallel with the object 3D vector fields of each of the plurality of candidate objects on their respectively assigned distinct processor apparatus. Alternatively, the plurality of candidate objects may be divided into a plurality of classes of object, and each class of object is assigned to a distinct processor apparatus and compared with each of the plurality of sub fields on the assigned processor apparatus. Alternatively, the plurality of candidate objects may be divided into a plurality of classes of object, and each combination of class of object from the plurality of classes of object and sub field from the plurality of sub fields is assigned to a distinct processor apparatus, and the comparison between candidate objects from the respective class of object with the respective sub field is performed on the respectively assigned processor apparatus.

In an example, the plurality of candidate objects may be divided into a plurality of classes of object and the database may be populated (e.g. by downloading object data into the database) based on the classification of one of the objects as belonging to a particular class. Therefore, in some examples, if it is determined that a candidate object is present in the imaged domain and is belonging to a particular class of the plurality of object classes, then then the method further comprises storing, in the object model database, only those candidate objects belonging to the particular class. Storing may comprise populating the database, e.g. receiving candidate objects belonging to the particular class or storing may comprise restricting the database so that it only includes candidate objects belonging to the particular class (e.g. by excluding those candidate objects from then database that do not belong to the particular class). In this way if an object (for example a new object) is recognised as being part of a railway then the method may comprise populating the database with object that belong to the class ‘railway’. In other examples, rather than populating the database, the method may comprise selecting a subset of data from the database, the selected subset belonging to the particular class of object.

A reduction in processing time is realised by parallelising some of the processing required to implement embodiments.

Furthermore, if one of the candidate objects is determined to be in the imaged domain based on comparing of one of the plurality of sub-fields with the object 3D vector field of said one of the candidate objects, the plurality of candidate objects for each of the other sub-fields among the plurality of sub-fields may be constrained to a subset of the plurality of candidate objects, the subset having fewer members than the plurality of candidate objects, and being selected based on the said one of the candidate objects determined to be in the imaged domain.

Advantageously, the parallelised processing threads can inform one another of results, so that a reduction in candidates for recognition can be achieved, thus saving processing resources.

Optionally, the information derived from the readings is information representing the whole or part of physical features represented by readings in the image data resulting from one or more of the lines or edges, surface or interface, surface roughness, reflectivity, curvature, contours, colours, shape, texture, planes, cylinders, tori, saddle point surfaces, ogive surfaces, quadric surfaces, material density, material absorption and/or materials of the physical feature itself and/or its ornamentation, wherein the physical feature may be a hole or gap in a plane or another physical feature, or an arrangement of multiple holes or gaps. Furthermore, the said information derived from the readings may be represented by a vector or vectors in the domain 3D vector field and/or stored in association with a vector of the domain 3D vector field as an associated attribute.

Optionally, the plurality of candidate objects is a subset of the population of objects stored in the database, each object among the population of objects being stored in association with a classification, the classification indicating one or more object classes to which the object belongs, from among a predetermined list of object classes. In such cases, the method may further comprise determining the plurality of candidate objects by: inputting to a classification algorithm the image data or the domain 3D vector field, the classification algorithm being configured to recognise one or more classes of objects to which objects represented in the input belong; the plurality of candidate objects being those stored in the database as belonging to any of the one or more recognised classes of object.

Advantageously, organisation of the object data database into classes, and the classification of the domain 3D vector field, provides a mechanism by which to reduce the number of objects in the plurality of candidate objects for which comparison processing is to be performed. Therefore, a reduction in processing cost is achieved.

Optionally, the at least one maximum is a plurality of local maxima, and the determining whether or not the respective candidate object is present in the imaged domain is performed for each local maximum in order to determine a minimum number of instances of the respective candidate object in the imaged domain; wherein either the placing or annotating is performed for each of the minimum number of instances of the respective candidate object determined to be in the imaged domain.

Advantageously, a single object may be recognised as appearing more than once in a scene represented by the image data. In this case the different objects will be separated by cutting up the space into subdivisions a little larger than the size of the object and repeating.

Embodiments may leverage a weighted average of several different vector types. In particular, the defined information-to-vector transform may be one of a set of plural defined information-to-vector transforms, each to convert respective information derived from the readings in the image data into vectors of a respective vector type, each of the vectors being positioned (and optionally, in some examples, oriented) in the 3D vector field in accordance with positions (and optionally, in some examples, orientations) of the readings represented by the respective vector in the image data In such cases, the converting may comprise, for each member of the set of plural defined information-to-vector transforms, deriving the respective information from the readings in the image data and using the defined information-to-vector transform to convert the derived information into a domain 3D vector field of vectors of the respective vector type, each of the vectors being positioned (and optionally, in some examples, oriented) in the 3D vector field in accordance with positions (and optionally, in some examples, orientations) of the readings represented by the respective vector in the image data; and each of the plurality of candidate objects may be stored as a plurality of object 3D vector fields in the object data database, the plurality of object 3D vector fields comprising one object 3D vector field derived from a transform corresponding to each member of the set of plural defined information-to-vector transforms and thus representing the respective candidate object in vectors of the same vector types as the vector types of the corresponding domain 3D vector field into which said member transforms information derived from readings in the image data. The comparing is performed for each pair of domain 3D vector field with its corresponding object 3D vector field of vectors of the same vector type, and determining whether or not the respective candidate object is present in the imaged domain is based either: on a weighted average of the degrees of match of the at least one maximum for one or more of the pairs in the case where more than one vector type has a maximum; or, in the case where only one vector type has a maximum, based on the maximum for that vector type. By way of example, in the case where only one vector type has a maximum the weighting will be 1 for that vector type and 0 for the others. The weighting may be decided after all degrees of match have been determined.

By combining correlation calculations for plural vector types, particularly robust/accurate recognition results are achievable. For example, this may be beneficial in implementation scenarios with many visually similar candidate objects.

The object data database stores representations of candidate objects in a predetermined format suitable for insertion into the obtained image data. Optionally, the predetermined format in which the first representation of each of the plurality of candidate objects is stored is a data format encoding information about the appearance of the candidate object and material properties of the candidate object, which material properties include labelling entities within the candidate object as being formed of an identified material, wherein said data format may be CAD data, and optionally wherein the predetermined format is a mesh format, a voxel format, Industry Foundation Classes (IFC) format, DWG format, or a DXF format.

Degree of match between 3D vector fields is utilised for rotational and/or translational alignment. Optionally, the degree of match between the vectors of the domain 3D vector field and the vectors of the object 3D vector field is quantified by calculating a mathematical correlation between the vectors of the domain 3D vector field and the vectors of the object 3D vector field as the degree of match.

In addition to object recognition via rotational alignment, embodiments may perform translational alignment of candidate objects within a domain. For example, embodiments may include using an object 3D element field representing the or each candidate object determined to be in the imaged domain, and a domain 3D element field representing a relevant portion of the domain, to find a translational alignment of the candidate object within the relevant portion of the domain, wherein the relevant portion is the portion corresponding to the sub-field of the domain 3D vector field in which the respective candidate object is determined to be in a case in which the domain 3D vector field is divided into sub fields for the comparing, and wherein the relevant portion is the entire domain 3D vector field otherwise, wherein the object 3D element field and the domain 3D element field are either 3D vector fields, with each element in the object and domain 3D element fields being a vector from the respective 3D vector field, or 3D point clouds, with each element in the object and domain 3D element fields being a point from the respective 3D point cloud, and in the case of 3D point clouds: the method includes obtaining the domain 3D vector field as a 3D point cloud, being the domain 3D element field, or each sub-field of the domain 3D vector field as a 3D point cloud, being the domain 3D element field, and obtaining the object 3D vector field of the or each candidate object determined to be in the imaged domain, rotated to the relative rotation giving the at least one maximum degree of match determined to indicate presence of the respective candidate object in the imaged domain, as a 3D point cloud, being the respective object 3D element field. And in the case of 3D vector fields: the domain 3D element field is the relevant portion of the domain 3D vector field, and the object 3D element field is the object 3D vector field of the respective candidate object determined to be in the imaged domain, rotated to the relative rotation giving the at least one maximum degree of match determined to indicate presence of the respective candidate object in the imaged domain.

The method may further comprise, for the or each candidate object determined to be in the imaged domain: for a line and a plane in a coordinates system applied to the 3D representation of the domain provided by the image data, wherein the line is at an angle to or normal to the plane: record the position, relative to an arbitrary origin, of a projection onto the line of each element among the domain 3D element field, and store the elements in the recorded positions as a domain 1-dimensional array, and/or store a point or one or more properties or readings of each element at the respective recorded position as the domain 1-dimensional array; record the position, relative to an arbitrary origin, of a projection onto the plane of each element among the domain 3D element field, and store the elements in the recorded positions as a domain 2-dimensional array, and/or store a point or one or more properties or readings of each element at the respective recorded position as the domain 2-dimensional array; record the position, relative to the arbitrary origin, of the projection onto the line of each element among the rotated object 3D element field, and store the recorded positions as an object 1-dimensional array, and/or store one or more properties or readings of each element at the respective recorded position as the object 1-dimensional array; record the position, relative to an arbitrary origin, of a projection onto the plane of each element among the rotated object 3D element field, and store the recorded positions as an object 2-dimensional array, and/or store one or more properties or readings of each element at the respective recorded position as the object 2-dimensional array; find a translation along the line of the object 1-dimensional array relative to the domain 1-dimensional array at which a greatest degree of matching between the domain 1-dimensional array and the object 1-dimensional array is computed, and record the translation at which the greatest degree of matching is computed; and find a translation, in the plane, of the object 2-dimensional array relative to the domain 2-dimensional array at which a greatest degree of matching between the domain 2-dimensional array and the object 2-dimensional array is computed, and record said translation. The output may be one of: a vector representation of the recorded translation along the line and in the plane; the obtained image data annotated to indicate the presence of the respective candidate object in the imaged domain, at a location determined by the recorded translations; and/or the obtained image data with the predetermined format data representation of the respective candidate object in the obtained image data rotated to the relative rotation giving the at least one maximum degree of match determined to indicate presence of the respective candidate object in the imaged domain, at a location determined by the recorded translations, replacing the co-located obtained image data. In some examples, a filter may be applied to the points in the point cloud before their projection onto the plane or line, and the filter applied to points that are to be projected on the line than on the plane.

The one or more properties or readings may be referred to as associated attribute values.

Furthermore, in the case of the elements of the object 3D element field and the domain 3D element fields being vectors, the degree of match between the domain 2-dimensional array and the object 2-dimensional array, and/or between the domain 1-dimensional array and the object 1-dimensional array, is quantified by, for each vector in a first of the two respective arrays, calculating a distance to a closest vector or a closest matching vector in the other of the two respective arrays, said closest matching vector having a matching magnitude and direction to the respective vector to within predefined thresholds, and summing the calculated distances across all vectors in the first of the two respective arrays, including adding a predefined value to the sum if no closest matching vector is found within a predefined maximum distance. The two vector models may be moved relative to each other to minimize the sum of the distances between them. The distance and/or direction required to move the two models together to bring them into alignment may be recorded (e.g. stored). The candidate object may be rotated to a correct orientation in the domain field. Additionally or alternatively, and as described elsewhere herein, minimising the sum of distances may be used to place the candidate object in position.

Such embodiments provide a translational alignment procedure allowing the representation of the object in the predetermined format to be placed in the 3D image data at the correct location. The use of a plane and line is particularly computationally efficient, and accurate.

The 2-dimensional array and/or the 1-dimensional array may comprise, or be defined at least in part, by a point density histogram.

By recognising point cloud objects and replacing them by CAD objects, embodiments create a CAD BIM Digital twin model of the whole scene in which objects are accurately placed and orientated.

Objects within a class may be compared to each other by the methods of part of the rotational and translational comparisons and similar objects may be put into a subclass.

Embodiments may include finding a scale of the or each candidate object determined to be in the imaged domain by finding a maximum correlation of a scale variant transform applied to the respective object 3D vector field and a relevant portion of the domain 3D vector field, and scaling the respective object 3D vector field in accordance with the scale giving maximum correlation.

Optionally, the object metadata stored with the first representation of each candidate object is an identification of a name, and/or a manufacturer and model number, of the candidate object.

Embodiments of another aspect of the present invention may include a computing apparatus comprising at least one processor and a memory, the memory configured to store processing instructions which, when executed by the at least one processor, cause the at least one processor to perform an image processing method embodying the present invention. Embodiments of another aspect of the present invention may include a computer program comprising processing instructions which, when executed by a computing device comprising a memory and at least one processor, cause the at least one processor to perform an image processing method embodying the present invention.

In summary, embodiments may be used to:

replace objects of one format with objects of another format;

find all occurrences of a particular object within a 3D scene;

find the location and orientation of all objects of interest (i.e. all objects composed of features extracted by a segmentation algorithm) in the domain;

find the damage, deviation of the actual object in the 3D environment from the ideal object in the database.

find the change in location or orientation of an object;

find the change in presence or absence of an object in a room or building or outdoor scene.

### BRIEF DESCRIPTION OF THE FIGURES

FIG. 1 illustrates an image processing method of an embodiment.

FIG. 2 illustrates an optional processing flow between steps S102 and S103 of FIG. 1.

FIG. 3 illustrates an optional processing flow after step S103 of FIG. 1.

FIG. 4 illustrates an exemplary process for calculating a position within the domain of an object determined to be in the domain.

FIG. 5 is a block diagram of a computing device, such as a server, which embodies the present invention, and which may be used to implement a method of any of the embodiments.

### DETAILED DESCRIPTION

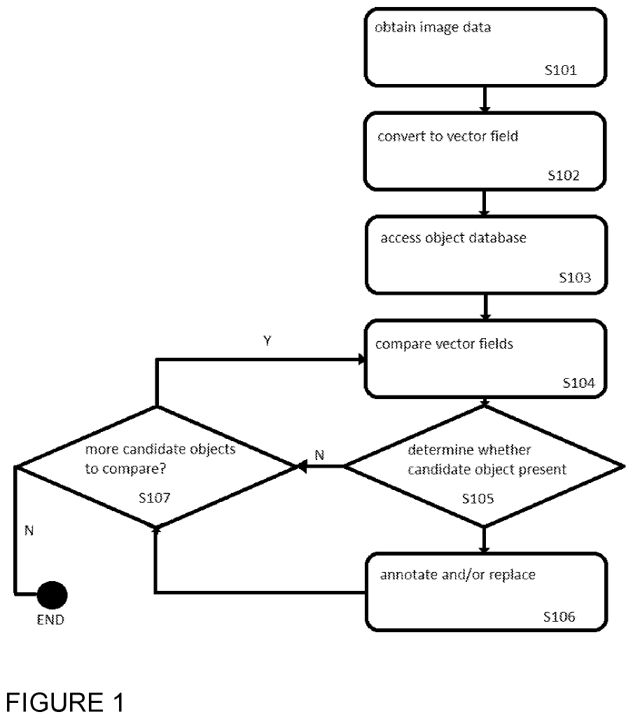

### FIG. 1

FIG. 1 illustrates an image processing method of an embodiment. The image processing method recognises objects in an imaged domain from among a database of stored objects, and enhances the image data by either supplanting the representation of the recognised object in the original image data with a representation of the recognised object in a predetermined format, or by annotating the representation of the recognised object in the original image data with metadata identifying the recognised object.

S101 Obtain

At S101 image data is obtained. The image data comprises readings providing a 3D representation of a domain.

### Image Data

The image data may be obtained from an imaging apparatus, as one or multiple scans combined to form a 3D representation of the domain. The image data may be obtained from photogrammetry where one moving camera takes multiple photos or where two or more cameras take photos and then a point cloud is derived from the photos. The imaging apparatus is operable to take readings within a space (the domain). The readings are, for example, locations of emission or reflection or absorption of a wave or particle detected by the imaging apparatus. The imaging apparatus is operable to interpret readings as physical features within 3D space, and to generate a data point in a point cloud corresponding to the reading. A physical feature may be, for example, a surface or an interface between two materials, or between regions of different densities. The imaging apparatus used to generate the image data may image using one or more imaging techniques from among, for example, X-ray scanning, MRI scanning, LIDAR, RADAR, sonar, electrical resistivity tomography inserted into the ground to scan a subterranean space, electrical impedance tomography.

### Readings

The reading can record the distance from the imaging apparatus to the point determined to be the represented by the reading. Readings can record such values as position in x, y, z Cartesian coordinates or in cylindrical or spherical or geographic or other coordinates such as space-time. The reading can include date and time and person or instrument doing the recording as well as the resolution set and power of the laser used. The reading can record the strength of the reflected or transmitted or absorbed signal from the laser or sound wave. The reading may record the intensity and colour of any light or radiation or sound emitted from the point and detected by the apparatus. The reading may also include a property of the point and its neighbouring points such as the curvature of the surface and the position and orientation of a small flat plane patch fitted to the point and its neighbouring points which can be represented as a surface normal vector. The reading may also include derived properties such as the divergence of the surface normal vectors and whether the curvature is positive or negative and the direction of the surface normal vector. The reading can record the resistivity or conductivity or capacitance or inductance or electrical complex permittivity or magnetic complex permeability of the space or the speed of travel of electromagnetic or sound waves at that point. The reading may record the colour of a surface (or distribution of colour in a pattern on a surface) of volume in r, g, b coordinates or in any of the following colour coordinates CIELAB, CIELUV, CIExyY, CIEXYZ, CMY, CMYK, HLS, HSI, HSV, HVC, LCC, NCS, PhotoYCC, RGB, Y′CbCr, Y′IQ, Y′PbPr and Y′UV (reference https://people.sc.fsu.edu/˜jburkardt/f_src/colors/colors.html). The reading may record the texture or roughness of a surface or the material of which the surface is made or material of which a volume is made. The reading may record any local movement velocity and acceleration and period and vector direction of the point being read over a short time scale by using a method such as Doppler. Note that when the imaging apparatus looks in one direction it may receive back more than one reading. If there is a solid opaque surface there will be generally one reading. But if the surface is slightly transparent or if there is no surface and it is just a volume being imaged there may be thousands of readings from different distances away from the imaging apparatus which distinguishes them from each other. So, for example, a reading may be x,y,z,r,g,b.

It is computationally efficient to subsample the data first sparsely, trying to give a uniform point density on each surface. Later the degree of subsampling can be reduced so it is denser and denser and the angular rotation steps S104can be made finer and over a smaller range of angles until the result no longer changes and it has converged.

It is computationally efficient to first convert the input format of point cloud to another format of point cloud which can then be further processed more efficiently. Similarly, at the output S106 as the user may want the object to be extracted and output in a certain point cloud format.

### Domain

The domain may be a space wholly or partially enclosed by walls. Alternatively, the domain may be an open space. The domain may be populated by one or more objects. One or more of the objects may be instances of objects stored in an object data database, discussed in more detail below.

### S102 Convert

At S102 the image data is converted to a domain 3D vector field consisting of vectors representing the readings as vectors by deriving information from the readings in the image data and using a defined information-to-vector transform to convert the derived information into vectors, each of the vectors being positioned and, in some examples, also oriented in the domain 3D vector field in accordance with positions and (in those examples where the vectors are also oriented) orientations of the readings represented by the respective vector in the image data.

### Converting the Image Data to Vectors

An information to vector transform may be applied to image data generically rather than from a specific format of image data. Thus, the deriving information from the image data may be considered a preprocessing step in the conversion, which preprocessing step removes heterogeneities associated with different formats of image data. For example, the vectors may be edge vectors (vectors representing edges of and between surfaces). In some image data formats or representations, the edges may be explicitly registered, whereas in others the edges may need to be derived from, for example, point cloud data. For example, the derived information is information representing the whole or part of physical features represented by readings in the image data resulting from one or more of the lines or edges, surface or interface, surface roughness, reflectivity, curvature, contours, colours, shape, texture, planes, cylinders, tori, saddle point surfaces, ogive surfaces, quadric surfaces, material density, material absorption and/or materials of the physical feature itself and/or its ornamentation. Physical features includes both geometric features and surface (or interface) features.

The precise techniques for deriving information from the image data, and transforming the derived information to vectors, is implementation specific. It is noted that embodiments may utilise plural techniques, so that there is more than one domain 3D vector field representing the domain. Embodiments may convert image data into surface normal vectors, by deriving information about the surface represented by a reading from the reading and neighbouring readings, and executing a surface to vector transform on said derived information.

For example, the vectors may represent a notional surface formed by the respective point and neighbouring points. Alternatively, the vectors may represent some other geometrical or other property of the image data. For example, if the image data represents an object such as an organ inside the body, there may not be any surfaces but just a 3D spatially varying set of readings. The vectors may be calculated by finding, for each point, the maximum gradient for each of the variables recorded in a reading.

The image data is converted into one or more domain 3D vector fields. There may be a one:one correspondence between readings of the image data and vectors, or there may be a sampling ratio to reduce the number of vectors relative to the number of readings. For example, the millions of points on a flat plane or on a cylinder may be represented by one vector. This gives a large improvement in subsequent processing, storage, communication efficiency. A reading by the imaging apparatus may be represented by a point in the image data or by some other entity in the image data. Neighbouring points within image data form notional surfaces, that is to say, notional surfaces can be fitted to groups of points or readings within image data. The converting may include, for each point of inquiry, generating a vector to represent a notional surface fitted to the point of inquiry and neighbouring points. The notional surface is thus referred to as derived from the respective point and neighbouring points. The notional surface is exemplary of information derived from the image data. There is a predefined mapping of notional surfaces to vectors, which predefined mapping is exemplary of an information to vector transform. It will be appreciated that neighbouring points may be selected in different ways according to implementation requirements. Furthermore, it will be appreciated that various algorithms can be selected for the fitting of the notional surface to the group of points, and for generating a vector to represent said notional surface.

The readings themselves or attributes associated with the respective reading may be used as a basis from which to derive information, and the derived information transformed to vectors.

### Vectors

The vectors have position, direction, and magnitude, and with a combination of those properties represent a feature of the image data. The vectors may also have associated attribute values. The feature of the image data may be a point, or reading, or a number of points or readings represented by a single vector. Grouping of points or readings may be due to them neighbouring one another, and/or being determined to be part of the same object or geometric feature in the image data. Positional information is removed from the vectors for analysis in the comparing step S104. Optionally, magnitude information may also be removed at this step, i.e. so that the vectors all become unit vectors.

A domain 3D vector field and a object 3D vector field are respectively unique patterns representing a subject by an arrangement of vectors in a notional three-dimensional space, each vector positioned and, in some examples, also oriented at a feature it represents, the direction and optionally also magnitude and/or associated attribute values of the vector encoding information about the represented feature.

Techniques for converting image data to vectors may include recognising basic geometric shapes as distinct objects (exemplary of information derived from the image data), and representing instances of the same basic geometric shape as vectors of a vector type corresponding to said basic geometric shape. For example, a 3D vector field of vector type “cylinder vector” is generated from the instances of cylinder in the image data. Similarly one or more from among planes, edges, curved cylinder, straight and curved edges, bent pipes with various radius and various bends and combinations of bends through angles of 90 degrees and all other angles; circular cylinders and partial cylindrical lip edges (quantify and plot the curvature along the edge both parallel and perpendicular to the edge); circular holes, slot holes, circular edges and partial edges; sphere and partial spheres; cones, cone frustums; circles; pyramids and pyramid frustums; toroids and other conic solids and sections; quadric surfaces; saddle points; hyperboloids; gaussian volumes; corners; points where several planes intersect; lines or edges; surface or interface; surface roughness; reflectivity; curvature; contours; colours; shape; texture; planes; cylinders; tori; saddle point surfaces; ogive surfaces; material density; material absorption and/or materials. In this way, objects in the scene being captured (e.g. when obtaining the image data) may be approximated, or recognised, or identified, as any one of the geometrical objects listed in the preceding sentence and the comparison may comprise determining whether there is a match between the geometrical object (e.g. plane) found in the scene and a stored representation of an object, e.g. stored in the database. Image data may be smoothed using various filters including bilinear to remove texture, rust, flaky paint, bark. An example is a curved railway rail. In this case embodiments may represent the inside and outside curvature of the curved rail as curved cylinders and the top of the rail which is also curved from side to side as another cylinder. So there is a hierarchy of vectors as once the rail is recognised as being a rail composed of the top edge inside and outside and middle vectors, then embodiments may replace them all by one vector called a rail vector which is useful for further processing of the scene. Then recognise the object. Later the texture can be put back and recognised separately. In each case, a predefined mapping is used to convert the basic geometric shapes to vectors i.e. to determine how a particular instance of the shape should be represented as a vector.

The hierarchy of vectors includes, for example, at the bottom of the hierarchy: basic or fundamental features of objects such as edges, planes, and cylinders, are represented by vectors. At a higher level of the hierarchy: composite or complex features such as objects or portions of objects are represented by a single vector representing a composite or collection of vectors representing constituent basic or fundamental features of the object.

Deconvolution may be applied using appropriate Gaussians to represent range, elevation, azimuth noise removes the blurring effect of noise.

The vectors of the domain 3D vector field and the object 3D vector field may each be a set of the following vector types:

surface normal unit vectors,

sum vectors,

divergence vectors,

edge vectors,

cylinder vectors,

complex object vectors,

plane vectors,

point density gradient vectors,

circular hole vector, slot hole vector, (any other shape of hole vector),

curved cylinder vector,

point density gradient divergence vectors, and

gradient vectors.

Wherein, in the comparing, the degree of match is calculated as a combination of the degrees of matching for the respective particular types, the combination being an average or a weighted average.

In a case in which one of the particular types is sum vectors: the vectors of the domain 3D vector field are sum vectors, and the vectors of the object 3D vector field are sum vectors; and transforming the first 3D point cloud (representing the domain) into a first set of sum vectors and transforming the second 3D point cloud (representing the object) into a second set of sum vectors, comprises: for each 3D point cloud individually, for each point in the respective point cloud as an inquiry point: form a search radius sphere of predetermined radius around the inquiry point or find a specific number of nearest neighbour points; calculate vectors from the inquiry point to all other points within the search radius sphere or within the near neighbourhood; perform vector addition on the calculated vectors to obtain the sum vector.

Optionally, the vectors of the domain 3D vector field are surface normal unit vectors, and the vectors of the object 3D vector field are surface normal unit vectors; and transforming the first 3D point cloud into a first set of surface normal vectors and transforming the second 3D point cloud into a second set of surface normal vectors, comprises generating the first set of surface normal vectors and generating the second set of surface normal vectors by: for each 3D point cloud individually, for each point in the respective point cloud as an inquiry point: selecting a set of neighbour points, calculating a covariance matrix for the set of neighbour points and the inquiry point; solving the covariance matrix to find the three eigenvalues and three eigenvectors for the covariance matrix, determining the eigenvector with the smallest eigenvalue, normalising the eigenvector to a predetermined unit length, adding the normalised unit vector to the respective first or second set of normal vectors.

Optionally, selecting the set of neighbour points for the inquiry point comprises either selecting each of the points within a sphere of a predefined radius with an origin coincident with the inquiry point, or selecting the N nearest points to the inquiry point; and transforming the first 3D point cloud into a first set of surface normal unit vectors and/or transforming the second 3D point cloud into a second set of surface normal unit vectors further comprises: storing the respective set of surface normal unit vectors as a reference set of normal unit vectors; repeating the generating the respective set of surface normal unit vectors with a progressively smaller radius of the sphere until a minimum radius is reached, at which point the repeating is terminated and the reference set of surface normal unit vectors is set as the respective set of surface normal unit vectors, at each repetition: determining a degree of confidence with which the respective set of surface normal unit vectors generated in the repetition match the reference set of surface normal unit vectors, and if the determined degree of confidence satisfies a predetermined criterion, setting the reference set of surface normal unit vectors as the respective set of surface normal unit vectors, and terminating the transforming, and if the determined degree of confidence does not satisfy the predetermined criterion, replacing the stored reference set of surface normal unit vectors with the respective set of surface normal unit vectors generated in the repetition, and continuing the repeating.

Optionally, edge detection is performed using the sum vectors (each sum vector may be analysed on its own, or with one or more neighbouring sum vectors), wherein the magnitude of the sum vectors are used to detect sum vectors representing edges and those representing corners, with larger magnitude indicating a vector representing an edge; and surface feature detection is performed by calculating the vector dot product of the sum vector originating from a point of the point cloud and one or more nearby surface normal vectors (e.g. originating from the same point), the angle having a cosine that is equal to the calculated vector dot product indicating the presence of a surface feature, and identifying the surface feature as an edge, a convex edge, a concave edge, a corner, or a hole or occlusion. At a hole the sum vector points away from the hole. At an edge the sum vector on an adjacent surface points away from the edge.

Optionally, transforming the stored first 3D point cloud into a domain 3D vector field (first set of vectors), and transforming the stored second 3D point cloud into an object 3D vector field (second set of vectors), wherein each member of the first set of vectors and each member of the second set of vectors represents the respective point and neighbouring points, includes executing an autoencoder on the stored first and second point clouds, or on a set of vectors representing said point clouds, the autoencoder being an unsupervised deep learning algorithm for extracting features within the 3D space; wherein the extracted features are represented by corresponding vectors in which position, orientation, and magnitude of the vector is determined by position, orientation, and dimension or dimensions of the extracted feature. The autoencoder is a set of weighted interconnections between every input point and every output point, in which the weights have been found by standard training algorithms but with the same pattern or image being presented at both the input and at the output. An alternative way to automatically find the most relevant features may comprise training a neural network artificial intelligence having many layers of neurons, such as a feedforward multilayer perceptron so that when a point cloud or voxelised object is input the same object comes out at the output. This may be done by putting the same object into both the input and into the output many times and running a training algorithm. This may be repeated with other objects. Then the whole cycle may be repeated many times. This trained neural network is sometimes called an autoencoder. The weights connecting the neurons may then have been trained to recognize different features which best distinguish all the training objects from each other. The first few layers of the multilayer neural network at each end may have been trained to recognise simple features such as edges and planes. The layers a little closer to the centre of the neural network may be recognizing more complex features made up from the simple features such as corners. The central layers may be, like the vector model, in that they will be recognizing objects made up of combinations of edges, planes, corners each in a particular place and orientation relative to the other simple features. Sometimes these features are called internal representations of various orders or levels depending on the layer of the multilayer neural network. There may be a way to find and extract and visualize the features being recognized by each layer after training. This method may be a better way to find features in certain examples such as for unknown environments for which no data may be available. The unknown environment according to this method may be laser scanned and the images put into both the input and output of a multilayer neural network. It is trained as an autoencoder and the features are then extracted. More detail is available in:

Selviah, D. R., J. E. Midwinter, A. W. Rivers, and K. W. Lung. “Correlating matched-filter model for analysis and optimisation of neural networks.” In IEE Proceedings F (Radar and Signal Processing), vol. 136, no. 3, pp. 143-148. IET Digital Library, 1989.

And in:

Selviah, D. R., and J. E. Midwinter. “Extension of the Hamming neural network to a multilayer architecture for optical implementation.” In 1989 First IEE International Conference on Artificial Neural Networks,(Conf. Publ. No. 313), pp. 280-283. IET, 1989.

And in:

Selviah, D. R., and J. E. Midwinter. “Memory Capacity of a novel optical neural net architecture.” ONERA-CERT, 1989.

The method by which the standard learning algorithm extracts features is described in these papers:

Stamos, Epaminondas, and David R. Selviah. “Feature enhancement and similarity suppression algorithm for noisy pattern recognition.” In Optical Pattern Recognition IX, vol. 3386, pp. 182-189. International Society for Optics and Photonics, 1998.

And in

Selviah, David R., and Epaminondas Stamos. “Similarity suppression algorithm for designing pattern discrimination filters.” Asian Journal of Physics 11, no. 2 (2002): 367-389.

Optionally, embodiments transform the stored first and second 3D point clouds into first and object 3D vector fields, respectively, by, for each point in the respective point cloud as an inquiry point: calculating a surface normal; calculating an angle deviation between the surface normal at the inquiry point compared to the surface normal of all of the near neighbour points within a small search radius sphere or for a specified number of nearest neighbour points; calculating an average of the calculated angle deviations for the inquiry point; obtaining, as the vector for the inquiry point in the respective set of vectors, a divergence vector, the divergence vector being a vector having the direction of the surface normal calculated for the inquiry point, and having a length proportional to the calculated average; and filtering the first and second set of vectors by selecting those divergence vectors longer than a certain specified threshold value.

Optionally, transforming the stored first and second point 3D clouds into first and object 3D vector fields includes: finding planes by one or more from among: RANSAC plane detection, Hough Transform plane detection, and region growing based on surface curvature, surface normal angle deviation, colour, reflectivity or roughness and distance from the plane; finding the area of each plane; wherein the respective set of vectors includes a vector for each found plane, the vector being a plane vector, which is a surface normal vector having a length equal to the area of the plane. Further detail is in Annex C of the published version of United Kingdom patent application GB1701383.0 provides further details.

Optionally, the vectors of the first set of vectors include cylinder vectors, and the vectors of the second set include cylinder vectors; and transforming the first 3D point cloud into a first set of cylinder vectors and transforming the second 3D point cloud into a second set of cylinder vectors, respectively, comprises: using a method for recognition of cylinders in the respective 3D dataset and finding the radius, position and orientation of each recognised cylinder; including in the respective set of vectors, a cylinder vector for each recognised cylinder, the cylinder vector for the recognised cylinder lying along, and parallel to, the orientation of the axis of the recognised cylinder, being placed at the position where the cylinder is found, and having a length related to the radius of the recognised cylinder.

Optionally, the method for recognition of cylinders in a 3D vector field comprises: executing a segmentation algorithm to find potential cylinder candidates; choose two random points lying within a certain distance of one another and lying on the same potential cylinder; calculate a cylinder model for the potential cylinder on which the two points lie, the cylinder model comprising orientation, radius, and position; based on surface curvature or surface normal angle deviation of the cylinder model, investigate points within a predetermined distance of the cylinder surface and, for any investigated points having a surface curvature or surface normal angle deviation within a predetermined threshold range of the surface curvature or surface angle deviation of the cylinder model, region grow the cylinder model to include the investigated points.

Wherein each of the above may be used with or without appropriate filtering, smoothing, thresholding, averaging, centroid selection.

Each type of vector used in an embodiment represents a different type of feature, or property.

Optionally, embodiments may, before finding the degree of match between the 3D vector fields: filter the first and second sets of vectors by recognising, in both sets, surface normal unit vectors representing one of the template shapes, and removing from the respective sets surface normal unit vectors not recognised as representing one of the template shapes. Each template shape may be represented by a vector type corresponding to that shape.

As a further option, the recognising is implemented by executing a segmentation algorithm on a first set of surface normal unit vectors as the domain 3D vector field and on a second set of surface normal unit vectors as the object 3D vector field, respectively.

The template shapes are one or more of edges, planes larger than a threshold minimum, cylinders, tori, cones, spheres. Furthermore, the template shapes may be combinations of the primitive shapes (edges, planes larger than a threshold minimum, cylinders, tori, cones, spheres). Furthermore, the template shapes may be combinations of the primitive shapes at predetermined angular relation to one another. Template shapes may be flat planes larger than a threshold minimum, concave edges, convex edges, curved cylinder, bent pipes with various radius and various bends and combinations of bends through angles of 90 degrees and all other angles; circular cylinders and partial cylindrical lip edges (quantify and plot the curvature along the edge both parallel and perpendicular to the edge); circular holes, slot holes, circular edges and partial edges; sphere and partial spheres; cones, cone frustums; circles; pyramids and pyramid frustums; saddle points; hyperboloids; spheres; toroids and other conic solids and sections and quadric surfaces; gaussians volumes.

The segmenting can be on the basis of one or several attributes. These could be surface texture, periodicity of the surface texture, surface curvature, surface colour, surface roughness.

For the case of the template shape being edges, sum vectors could be used in place of surface normal unit vectors. Edges are extracted by selecting sum vectors with a length larger than some threshold or a local maximum length or having a certain angle to local surface normal vectors. Then the points of the point cloud which have such sum vectors form a line or distinguishable pattern wherever there is an edge. The sum vector method is described elsewhere in this document in more detail. Common patterns found would be labelled as template shapes bearing in mind that each template will be represented by its own single vector.

Another way to find template shapes (which may also be referred to as features, geometric features, spatial features) is to apply a threshold to select high point density regions on the Gaussian sphere (Gaussian sphere refers to the 3D vector field from which positional information is removed so that the vectors originate from a common origin) and ignore the other points. Or to find the highest local density regions and throw away the rest. One way to do this is to calculate the point density at each point on the sphere and then calculate the exponential or logarithm of the point density to give some weighting function to emphasise the high or low point densities respectively. Or to find the centroid of the points in a region of high point density. Or add vectorially together all of the vectors of the points within a certain area on the surface of the sphere. This may be followed by thresholding based on the resultant vector length.

Another method is to identify and remove any periodic features which may lead to incorrect alignment. This can be done by a 2D or 3D Fourier Transform after which high density points are suppressed or removed before inverse Fourier Transforming.

Advantageously, the use of template shapes emphasises the strong (i.e. high point density) physical features represented in the respective datasets. Therefore, the finding a best match between the angular distributions of the representative sets of vectors is facilitated, yielding accurate results with small computational cost.

### S103 Access

At S103 a database of object data (object data database or object database) is accessed, the objects populating the database being a population of objects potentially recognised in the imaged domain by embodiments. Step S103 may include accessing an object data database, wherein each of a plurality of candidate objects is, in a first representation, in a predetermined format, together with object metadata, and in a second representation, stored as a object 3D vector field having been derived from a transform corresponding to the defined information-to-vector transform.

### First Representation

The first representation is in a predetermined data format. The predetermined data format is determined at a time of population of the database (database being shorthand for the object data database), before the image processing method of an embodiment is performed. Similarly, the predetermined data format may be updated by a database administration or update process in order to modify or change the predetermined format. There may be plural predetermined data formats so that there is more than one first representation of each object, the selection of which first representation to use being determined at each execution of the image processing method based, for example, on a user input or on a global parameter indicating a selection of predetermined data format.

Optionally, the predetermined format in which the first representation of each of the plurality of candidate objects is stored is a data format encoding information about the appearance of the candidate object and material properties of the candidate object, which material properties include labelling entities within the candidate object as being formed of an identified material, wherein said data format may be CAD data, and optionally wherein the predetermined format is a mesh format, a voxel format, Industry Foundation Classes (IFC) format, a DWG format, or a DXF format.

The first representation of each object in the predetermined format is stored together with object metadata. For example, the object metadata stored with the first representation of each candidate object is an identification of a manufacturer and model number of the candidate object. The object metadata may also include information including one or more from among: indication of component material(s), one or more mechanical properties, one or more operating properties.

The predetermined data format may be a form of image data (for example, CAD data) that replaces the portion of the obtained image data representing the object, so that the image data representing the domain is a composite of the original image data format (for example, point cloud), and objects in the predetermined data format. This procedure can be repeated for every object, ultimately changing the whole of the original image data format into the predetermined data format. Any objects or points not so recognised may be segmented and added to the object database as new objects and represented in the predetermined data format.

### Second Representation

By a transform corresponding to the defined information-to-vector transform (i.e. the transform used to create the domain 3D vector field) it is meant that the object 3D vector field is a product of the same information to vector mapping as the domain 3D vector field, so that the two 3D vector fields may be compared in a meaningful manner The object recognition is based on comparison of the two 3D vector fields, so accuracy is improved if the vector representation of the object in the database (i.e. the object 3D vector field) is the same as the vector representation that would be produced (at S102) by the presence of the object in the imaged domain. Of course, embodiments are not reliant on absolutely identical vector representations, and can tolerate some variation in the information to vector mappings.

For example, the second representation of an object in the object data database (i.e. the object 3D vector field) may be obtained by using image data providing a 3D representation of the object in the same (or a different) format as the image data of the domain obtained at S101. An exemplary format is point cloud. In this example, the same process may be used for converting the image data of the domain to the domain 3D vector field as for converting the image data of the object to the object 3D vector field.

In another example, the domain 3D vector field may be a vector field consisting of cylinder vectors (i.e. vectors representing a cylinder in the image data, as identified in the information derived from the image data, as a vector (or one vector per unit length of the cylinder) with a direction determined by the principal axis of the cylinder and magnitude determined by radius of the cylinder). The information derived from the image data is the identification of the cylinders, their location, their principal axes, and their radius and lengths. The information to vector transform then codifies the vector used to represent the identified cylinders. It can be appreciated that the object 3D vector field could be generated using the same process for identifying cylinders and transforming them to vectors, and that the two 3D vector fields could be compared in a meaningful way. Alternatively, even if the process used in the case of the object 3D vector field was different (for example a different radius to vector magnitude mapping, or by transforming each cylinder to a vector rather than each unit length of cylinder to a vector), it can be appreciated that the two 3D vector fields could be compared in a meaningful way, even if some accuracy may be sacrificed.

By meaningful comparison, it is taken to mean that an object present in the domain 3D vector field will give rise to a representation of the object in the domain 3D vector field that has a higher mathematical correlation with the object 3D vector field representing the object than that of an arbitrary object.

### Database

The object data database is accessible to the computing hardware performing the image processing method. For example, the object data database may be stored on data storage local to said computing hardware, or may be stored on remote data storage to which said computing hardware is configured to establish a data communication link. For example, most common or likely objects may be stored locally to the processor, with other objects accessible from a remote location via a link.

Each entry in the object data database is a representation of a candidate object, for example, signal box, model number X made by manufacturer A. Examples of other objects that may be recognised include: crossing, lineside furniture (miscellaneous minor structures), overbridge platform, signal and telecommunications structures, signal, underbridge, tunnel, viaduct, wall, rails, vegetation.

Signal box may be a classification of the entry, and the model number and manufacturer may be stored as metadata along with the first representation. The first representation may be, for example, a CAD data representation. There are also one or more second representations, i.e. object 3D vector fields, representing the object as one or more different types of vectors. There may be a hierarchical system of classifications of entries in the object data database, so that classes, sub-classes, and super-classes, may be identified, linked, and accessed together or in association with one another.

The object data database may be populated by accessing public and private libraries of object data, converting representations of objects to image data (eg point clouds), and then deriving information and converting said information to vectors in accordance with the defined information to vector transform for one or more vector types.

For example, the object data database may be the result of a collaboration with a private entity in which example some of the object data stored in the database may have been retrieved from a private database. In the process of retrieving such data from such a further database, the data may be converted, e.g. into a different representation or format. As part of this example storing object data in the database may comprise retrieving, e.g. automatically by a processor, stored data from a further database (and optionally converting the file format as mentioned above).

The object data database may be built up as a database library of point cloud, vector model, mesh, voxel basic objects classified into named categories. The database may include partial objects as seen in single scans and aligned scans. An example, is when a train or vehicle with a laser scanner on it travels it only scans nearby objects from one set of vantage points and not from behind so only partial object data is collected. Building up the database may include converting point cloud representations and mesh representations of objects to Voxel form for processing in Neural Networks. Embodiments may include converting the point cloud, vector model, mesh object, voxel object library database models from one to another model and storing all types of model of each object.

Embodiments may include a preparatory phase of building up an object data database of point cloud, vector model, mesh, voxel complex objects classified into named categories. The database may include all Industry Foundation Classes (IFC) objects and all objects segmented from all scans provided by customers and named by human observation categorised by size. Object manufacturers may provide CAD drawings of the objects commonly found in imaged domains. Building up the database may include: scanning and photographing a population of objects often attached to a board to obtain point clouds of their shapes (such sample/swatch boards are often made for new construction projects); segment, separate and label each object. Libraries of common variants of objects such as different types of girder may be built up. The libraries may be subdivided into countries, regions, decade, user company, as the typical types of one object varies according to these. The image processing method may ask at the start of the method execution for the postcode or zip code of the location, or user company, and load the appropriate library (i.e. constrain the selection of the plurality of candidate objects according to user location and/or user company).

At S104, the domain 3D vector field, representing the domain, is compared with the object 3D vector field. The comparing comprises finding at least one maximum, by relative rotation of the vectors of the domain 3D vector field with respect to the vectors of the object 3D vector field with the vectors positioned at a common origin, of a degree of match between the vectors of the domain 3D vector field and the vectors of the object 3D vector field. Positioning the vectors at a common origin means that it is the angular distribution, and length, of the two vector fields that are compared. This is computationally efficient when compared with approaches such as pair-wise comparisons of vector fields.

S104 of the method performs best match finding between the two sets of vectors, and, hence, the two sets are comparable. For example, the same technique, method, or algorithm is used to obtain both vector fields and hence they are comparable.

The principle is that the best rotational alignment between the domain 3D vector field and object 3D vector field is found. At this rotational alignment, the degree of match between the angular distributions of the two vector fields is used to determine whether or not the candidate object is considered to be present in the imaged domain.

Membership of the plurality of candidate objects may be determined by a user selection. For example, the objects stored in the object data database may be classified, and a user may select one or more classes of objects it is sought to recognise in the image data. The plurality of candidate objects is all objects in the object data database belonging to the selected class or classes. The user selection may be informed by a classification algorithm (see below re S102b) automatically identifying classes of object in the domain 3D vector field, the user then selects from among the identified classes. Alternatively, the user may select from among all classes in the object data database. The classes themselves may be organised according to a hierarchy of plural levels in which objects belonging to a given class include all objects indicated as being members of said class and sub-classes indicated to said class, and so on.

It is possible that a single object will give rise to more than one maximum, for example, where there is some degree of rotational symmetry. It may be that all maxima are recorded, and then at S105 filtering is performed based on recorded information about rotational symmetry of particular candidate objects to ensure that a single object is not determined to be present more than once by virtue of its rotational symmetry. On the other hand, it may be that a candidate object is present in the imaged domain at more than one orientation, and therefore there may be scenarios in which plural maxima are identified and each are determined to indicate the presence of an instance of the candidate object in the imaged domain. Maxima are peaks in the degree of match data, which may be found, for example, by finding the greatest degree of match and then determining that any degree of match within, for example, 10% is also a maximum. Alternatively, maxima may be found based on a degree of match being a predetermined number of standard deviations above the mean degree of match.

Effectively, one set of vectors is rotated about the other in each axis of rotation of interest until a best match is found. The degree of matching may be measured, for example, by using a mathematical correlation function/operator to compare the angular distribution of the two sets of vectors. For example, the mathematical correlation function/operator may be an existing mathematical correlation function/operator appropriate to the implementation. It is computationally efficient to Fourier Transform in 2 dimensions such as elevation angle and azimuth angle, each of the 2 inputs. Then multiply and inverse Fourier Transform. Then find all of the peaks. Put another way, to compare two sets of data to find a correlation and a degree of match, each set of data may first be transformed (e.g. using a Fourier Transform) and the two transformed (e.g. Fourier-transformed) sets of data may be multiplied and an inverse Fourier Transom may be applied to the result. As described elsewhere herein the data to be compared may be 2-dimensional with respect to an angle of elevation and an azimuthal angle, or 2-dimensional with respect to x and y axes on a plane, or 1-dimensional with respect to an axis (e.g. a z-axis) along a rod. To firstly Fourier transform the data has the advantage of saving computation and increasing the convenience of the process. Data, such as the 2-dimensional angle, 2-dimensional and/or 1-dimensional translation Fourier transforms may be stored, e.g. in the database, which may save repeated calculations in order to perform further correlations.

The three axes of rotation may be orthogonal, or may be two co-planar (but if two axes are co-planar they are precluded from being parallel) and one non-co-planar axes.

Step S104is to find at which angle of rotation the object 3D vector field exhibits the best match with the domain 3D vector field, and based on said best match to determine whether the candidate object represented by said object 3D vector field is present in the imaged domain. An exemplary process is: attributing a common origin to each vector in the first and object 3D vector fields is (for an example in which the vectors are surface normal unit vectors and thus each having an equal length), dividing a notional spherical surface centred on the common origin and having a radius equal in magnitude to the surface normal unit vectors into sphere surface regions, calculating the mathematical correlation between the frequency distribution of vector points per sphere surface region for the vectors of each vector field, rotating the object 3D vector field, and repeating the calculating. A step of normalising the lengths of each vector may be performed for vectors having non-equal lengths, for example, surface normal vectors. An alternative method for handling such vectors is outlined below, in which frequency distribution of vector ends per volume portion is considered. The rotating may be done in an incremental manner in each of the three angles of rotation until all combinations of angles have been covered for predefined ranges of angles about each rotational axis at a predefined level of granularity. Best match finding algorithms, such as simulated annealing, may be implemented to find the combination of angles at which the best match exists.

For an example in which another type of vector is used so that there are vectors of different lengths among the first and object 3D vector fields, the frequency distributions of vector ends per volume portion are correlated, with a notional sphere centred onto the common origin being divided into volume portions.

How to quantify the match

The mathematical correlation between the two sets of vectors (wherein a set of vectors is the vectors of one of the vector fields) may be found by dividing the angular space into regions of equal size, and comparing the number of vectors from each set in each region. Alternatively, the regions may be volume regions by dividing the volume surrounding the common origin into regions and comparing the numbers of vector ends in each region. An integrated value is calculated by summing across all of the regions, wherein a contribution to the integrated value from a particular region is proportional to the similarity in the number of vectors from the two sets ending in the region (for example, moderated according to the total number of vectors or the highest number of vectors from one set in a single region). As a particular example, the comparing may comprise multiplying the number of vector points from one set in one region by the number of vector points from the other set in the same region, and integrating the products over all sphere regions.

In the case of both the domain 3D vector field and the object 3D vector field, each vector has position, length, and magnitude. Further attributes may be associated along with each vector, including, for example, colour, reflectivity, surface roughness. The degree of match may also quantify the correlation between such associated attributes in each pair of vectors ending in the same region.

### Multiple Vector Types

Embodiments may be implemented wherein the defined information-to-vector transform is one of a set of plural defined information-to-vector transforms, each to convert respective information derived from the readings in the image data into vectors of a respective vector type, each of the vectors being positioned and, in some examples, also oriented in the 3D vector field in accordance with positions and (in those examples where the vectors are also oriented) orientations of the readings represented by the respective vector in the image data. The converting may comprise, for each member of the set of plural defined information-to-vector transforms, deriving the respective information from the readings in the image data and using the defined information-to-vector transform to convert the derived information into a domain 3D vector field of vectors of the respective vector type, each of the vectors being positioned and (optionally) oriented in the 3D vector field in accordance with positions and (optionally) orientations of the readings represented by the respective vector in the image data. Each of the plurality of candidate objects may be stored as a plurality of object 3D vector fields in the object data database, the plurality of object 3D vector fields comprising one object 3D vector field derived from a transform corresponding to each member of the set of plural defined information-to-vector transforms and thus representing the respective candidate object in vectors of the same vector types as the vector types of the corresponding domain 3D vector field into which said member transforms information derived from readings in the image data. The comparing is performed for each pair of domain 3D vector field with its corresponding object 3D vector field of vectors of the same vector type, and determining whether or not the respective candidate object is present in the imaged domain is based on a weighted average of the degrees of match of the at least one maximum for one or more of the pairs.

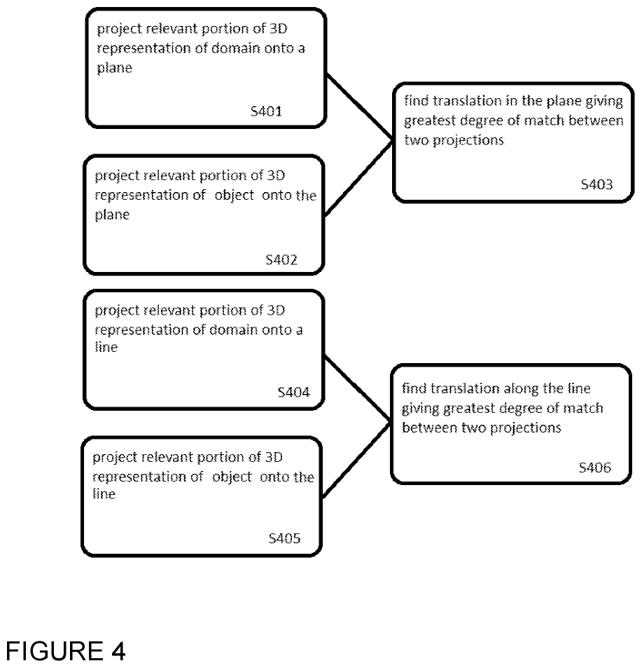

Particularly robust and accurate alignment results can be obtained by utilising more than one vector representation of each point cloud for alignment processing. This document sets out different possible choices of vector types in the description of FIG. 4. More information can be found in Annex B of the published version of United Kingdom patent application GB1701383.0.

Each type of vector represents a different aspect or quantity of the 3D subject of interest or represents them in different ways. So surface normal vectors represent a surface or part of a surface, sum vectors represent edges, corners, openings in planes and occlusions, divergence vectors represent edges and corners, spheres and cylinders and rough textured surfaces, edge vectors represent edges, cylinder vectors represent cylinders, pipes and columns, complex object vectors represent complex objects such as chairs, plane vectors represent the whole of a plane area, point density gradient vectors represent the direction of increase of point density which may also be the real density or reflectivity, point density gradient divergence represent where point density gradient vectors diverge such as near points of local high point density and gradient vectors represent the directions of increase of reading parameters such as colour, brightness, curvature, roughness. Therefore, it is advantageous to use several types of vector together to represent the features, structure and density present within the 3D subject of interest. This can either be done by constructing the same spherical representation construction described for surface normal vectors for each of the vectors in parallel and rotating the spheres together, performing each correlation or match for each vector in turn on each of the different vector spheres. Or all the different types of vector can be plotted in the same spherical representation but labelled with its own type. Then when the spheres are rotated and correlated the correlations are calculated separately between vectors of each type with those of the same type. For non-normalised vectors the space inside and outside the sphere between the minimum and maximum vector lengths is divided into radial and circumferential volume segments and the number of vector points or tips within each segment is multiplied by that for the other scan and summed to perform the mathematical correlation although other forms of matching can also be used such as summing segments coming into alignment and then summing all the sums.

A complex object such as a chair may need to be represented by more than one vector, for example, one pointing from the bottom to the top of the chair to see if it standing upright or has fallen over in which direction, and another vector pointing from the back to the front of the chair to say which way the chair is facing. These two types of vector must be kept separate in the sense that they must only be correlated and compared with vectors of the same type in the overlapping scan.

Embodiments can repeat the rotational alignment (and optionally also translational alignment) processing with a different vector representation, and the results combined. For example, surface normal vectors can be used in a first execution and sum vectors in a second. Any combination of two or more vector representations from among those disclosed in this document can be combined in the same manner

The results from the executions with different vector representations can be combined as follows:

The method includes finding all the rotations at which each type of vector, separately, has a local maximum correlation, and making a note of the correlations at that rotation for all of the other types of vector. The search method may use coarse angular steps to find several high correlation values and then may converge from each of those rotations using fine angular steps. The method includes making a table (see table 1 below) putting these rotation values in the first column and the correlation magnitude for each type of vector in each adjacent column. Adding together all of the correlations in each row and placing the sum in the right hand column. It is advantageous to multiply each column of correlations of each different vector type by a different weighting factor before carrying out the sum of correlations across a row. These weighting factors are determined experimentally or by knowing the relative importance of the different types of vector for different subjects of interest which can be specified at the start of the process.

TABLE 1
combining different vector representations

| | Correlations | Correlations | Correlations | |
|---|---|---|---|---|
| | of vector | of vector | of vector | |
| Rotation | type 1 | type 2 | type 3 | Sum of |
| angles | Weight W1 | Weight W2 | Weight W3 | Correlations |
| Alpha1, | C1, 1 | C1, 2 | C1, 3 | =W1*C1, 1 + |
| beta1, | | | | W2*C1, 2 + |
| gamma1 | | | | W3*C1, 3 |
| Alpha2, | C2, 1 | C2, 2 | C2, 3 | =W1*C2, 1 + |
| beta2, | | | | W2*C2, 2 + |
| gamma2 | | | | W3*C2, 3 |
| Alpha3, | C3, 1 | C3, 2 | C3, 3 | =W1*C3, 1 + |
| beta3, | | | | W2*C3, 2 + |
| gamma3 | | | | W3*C3, 3 |
| Alpha4, | C4, 1 | C4, 2 | C4, 3 | =W1*C4, 1 + |
| beta4, | | | | W2*C4, 2 + |
| gamma4 | | | | W3*C4, 3 |
| Alpha5, | C5, 1 | C5, 2 | C5, 3 | =W1*C5, 1 + |
| beta5, | | | | W2*C5, 2 + |
| gamma5 | | | | W3*C5, 3 |

International patent publication WO2018/138516 provides further detail on the processing steps for converting point cloud image data to vector fields of different vector types. The processing steps set out in that section may be utilised in embodiments of the present invention to convert the image data representing the domain and/or image data representing the candidate objects to vector fields, noting that preprocessing may be required to convert said image data to point cloud data.

### S105 Determine

At S105, the method comprises for the or each of the at least one maximum, based on the degree of match, determining whether or not the respective candidate object is present in the imaged domain.

Each maximum is recorded as a set of angles at which the object 3D vector field is rotated relative to the domain 3D vector field to provide the maximum, and a quantification of the degree of match between the two vector fields at said rotation based on the calculations in S104. The value of the quantification of the degree of match is compared with a threshold value, and if exceeded, it is determined that there is an instance of the candidate object represented by the pertinent second vector field in the imaged domain. The threshold may be dependent upon, for example, the relative size (i.e. number of points or readings) in the object 3D vector field relative to the domain 3D vector field, since (depending on how degree of match is calculated) an upper limit may be imposed by said relative size, so that the threshold is set as a proportion (for example, 90%) of the upper limit. The degree of match depends on the number of vectors so it is normalised by dividing by the number of vectors of that type in the object or partial object, if we are to compare it to a fixed threshold value. Otherwise embodiments can compare the maximum degree of match with the average degree of match across all angle rotations in this case or in other cases with different data and if sufficiently larger, such as by some factor of the average degree of match, then consider the object to be recognised.

The degree of match may be quantified in a manner which will indicate whether there a number of the respective candidate object at a particular orientation.

Where the domain 3D vector field is divided into sub fields via a segmentation algorithm extracting features or groups of features, it may be that the same or very similar feature or group of features appears as multiple instances in the domain. Should there be no candidate object from the object data database determined to be present in the said features or groups of features, said multiple instances may be linked with linking metadata, so that the object data database may be populated with a new object entry based on the representations of said multiple instances.

### S106 Annotate/Replace

At step S106, the image processing method includes placing the predetermined format data representation of the respective candidate object in the obtained image data at an orientation determined by the relative rotation of the two sets of vectors providing the at least one maximum degree of match; or annotating the obtained image data with the metadata of the candidate object determined to be present in the imaged domain.

For objects determined to be present in the imaged domain at S105, the image data being processed is augmented at S106. The augmentation is either by inserting into the image data the first representation (in the predetermined format) of the candidate object from the object data database into the image data. For example, the predetermined format may be selected by a user (from among those present in the object data database) as a data format that is required for downstream processing, for example, CAD data. The augmentation may also be by annotating the image data with metadata describing the object, for example, a manufacturer and model number. Therefore, the augmentation may comprise tagging or labelling the image data with metadata. The annotation may be associated with the image data as a whole, or may be associated with the particular portion of image data representing the object.

The annotation may be of the image data representing the domain with the metadata stored along with the first representation of the object or objects determined to be present in the domain. The annotation may be applied to the entirety of the image data (i.e. as metadata), or may be specific to a region at which the recognised object or objects is or are positioned.

S107 End?

Steps S104 and S105 are repeated for each of the plurality of candidate objects, in accordance with step S107, determining whether all candidate objects have been compared with the domain 3D vector field, and if not, continuing to iterate through the candidate objects. The procedure of S104 and S105 may be repeated for every candidate object, ultimately changing the whole of the original image data format into the predetermined data format. Any objects or points not so recognised may be segmented and added to the object database as new objects and represented in the predetermined data format.

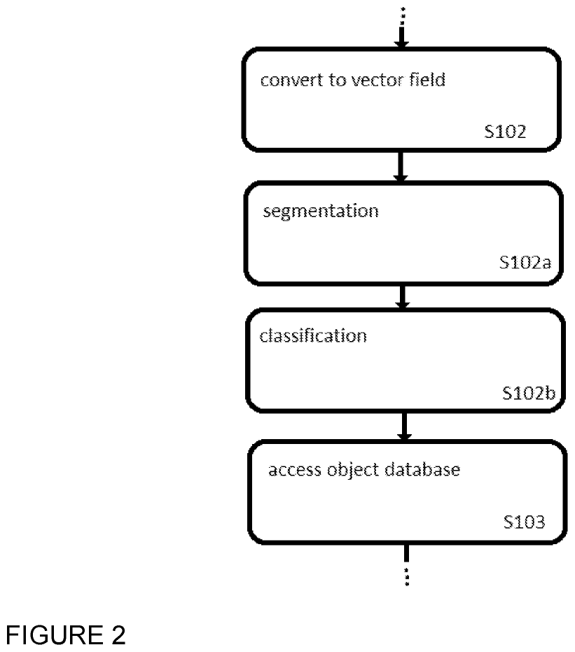

### FIG. 2

FIG. 2 illustrates an optional processing flow between steps S102 and S103 of FIG. 1. At step S102a, segmentation is performed on the domain 3D vector field. At step S102b, a classification algorithm is performed on the domain 3D vector field. The classification step S102b may be performed on the output of segmentation step S102a, alternatively, step S102b may be performed on the output of step S102 if no segmentation is performed. Likewise, the classification step S102b may be removed from the process and the segmentation step S102a remain.

### S102a Segment

At step S102a the domain 3D vector field obtained in S102 is segmented. The segmentation comprises executing a segmentation algorithm on the domain 3D vector field to remove objects and features identifiable as not being of interest, for example, walls, floors, ceilings, and other features which will be dependent upon the domain and the nature of the objects it is sought to recognise therein. Objects not of interest may be recognised first and removed. Alternatively a different algorithm can be used to recognise walls, floors, ceilings, edges, cylinders and remove them if they are of no interest. It may be that the removal of objects is adaptive based on the candidate objects. For example, objects (eg planes) larger than the largest among the plurality of candidate objects may be removed, but planes smaller may be retained. Alternatively, vice versa, objects of interest may be recognised by a segmentation algorithm and kept and labelled or tagged. Other non-recognised objects may be removed or left.

### S102b Classify

At step S102b, a user or a machine learning classification algorithm, identifies classes of objects present in the domain 3D vector field. Alternatively, the class of object may be input by a user. A class of object is a generic descriptor of a group of objects having entries in the object data database. The plurality of candidate objects may then be selected as all object data database entries that are members of classes identified as being present in the domain 3D vector field in classification step S102b.

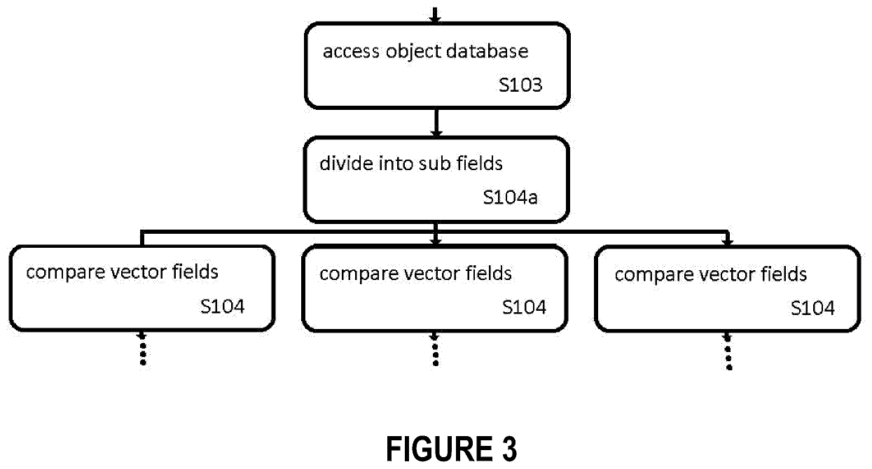

### FIG. 3

FIG. 3 illustrates an optional processing flow after step S103 of FIG. 1. At S104a the domain 3D vector field is divided into sub fields for comparing step S104. It is noted that steps S105, S106, and S107 are also executed on a per-sub field basis.

Alternatively, it may be that classification step S102b actually occurs after dividing step S104a. In such cases, the classes identified in each sub-field may be different, so that the plurality of candidate objects is defined differently for each sub-field.

### S104a Divide

The sub-fields may be continuous regions of the three dimensional space in which the domain 3D vector field is defined, and may overlap by a predefined percentage in each dimension. The size of the sub-fields may be predetermined or may be adaptive in dependence upon the size of the candidate objects. For example, the sub-field size may be approximately double (in each dimension) the size of the largest object among the plurality of candidate objects. The subfield may be about twice the size of the object being looked for. If looking for many objects of different sizes, it may be twice the size of the largest object. Embodiments may adaptively change the size of the subfield up or down after finding all objects of one size for which the size of the field is about twice the size of the object. When looking for long cylinder pipes embodiments may use 0.5 metre and 1 metre side cubes as the subfields. Embodiments may find the parts of the cylinder in each cube and finally join these parts back together again if they have the same radius, position and direction in the next door cube.

Sub fields may be features, or groups of features, extracted by a segmentation algorithm that extracts features or groups of features potentially matching candidate objects from features deemed not to be potentially matching candidate objects.

The processing may be parallelised so that each of plural processors is used for the comparing (and steps S105 to S107) of one or more sub fields.

Optionally, the domain 3D vector field may be divided into a plurality of sub-fields, and the comparing comprises comparing each of the plurality of sub-fields with the object 3D vector field of each of the plurality of candidate objects. In such cases, the comparing includes dividing the 3D representation of the domain into a plurality of sub-divisions, and each sub-field corresponds to a respective one of the sub-divisions. Alternatively, the sub fields are individual or groups of features extracted from the domain 3D vector field by a segmentation algorithm.

For example, the dividing step S104a may include cutting the 3D representation of the domain into volumes. The volumes include partial slides of the same volume along all axes to try to catch the whole object in the volume. In addition to direct search in these volumes methods may use correlation. An overlap of 40-60% may be chosen as a required amount of overlap.

There is an extra optimisation or fine recognition step which may be applied in each of the cases of rotational and translational matching where the degree of matching is of a very similar magnitude for different candidate objects. This could be carried out when it is found that the degree of matching is similar or, for higher speed recognition, it could be carried out after storing the object 3D vector field versions of the 3D objects in the database but before comparing a domain 3D vector field against them. This latter case can be found simply by comparing the vector formats of the various objects in the database with each other and finding which ones are similar by the degree of matching. The optimisation involves removing vectors or suppressing the weights (used to calculate degree of match on a per vector basis) of vectors which are similar in magnitude, direction, position and type between the similar objects in the database and enhancing the weights (used to calculate degree of match on a per vector basis) of the vectors which are not similar between the similar objects in the database. When an unknown object is to be recognised, first the usual vector models in the database will be used to distinguish which class and subclass of objects the unknown object belongs to and then the procedure will be carried out again for the similar objects in the class using the weighted vector versions.

### FIG. 4

FIG. 4 illustrates an exemplary process for calculating a position within the domain of an object determined to be in the domain. Conceptually, this is equivalent to calculating a position of the portion of image data representing a candidate object determined to be present in the domain (at S105) within the image data.

Point cloud representations of the relevant portion of the 3D representation of the domain, and of the candidate object, are obtained. The relevant portion of the 3D representation being either the whole of the 3D representation of the domain (in a case in which the comparing at S104is performed on the domain 3D vector field representing the whole of the domain without division into sub divisions), or, in a case in which the comparing comprises dividing the 3D representation of the domain into a plurality of sub-divisions, the sub-division corresponding to the sub-field based on which the candidate object is determined to be present in the imaged domain.

The candidate object to be placed, or the point cloud representation thereof, is rotated to the rotation giving the local maximum degree of match at S104that gives rise to the determination at S105 that the candidate object is present in the domain (or sub-division thereof), as a preprocessing step before the method of FIG. 4.

Obtaining the point cloud representations may be simply reading said point cloud representations from memory. For example, a point cloud representation of each candidate object may be generated in the course of generating one or more 3D vector field representations of the candidate object, in which case, the point cloud representation may be stored in the object data database as part of the database entry of the candidate object. The image data providing a 3D representation of the domain may be a point cloud, or a point cloud may be generated therefrom as a means to generating one or more 3D vector field representations of the domain from the image data. In which case, the point cloud representation may be stored in memory at least for the duration of the image processing method.

If the 3D vector field representing the domain is divided for comparison processing at S104, then a coarse translational alignment has already been performed, since each candidate object determined to be present in the domain has been determined to be in a particular one of the sub divisions. Therefore, the alignment processing set out in FIG. 4 need only be performed within the context of the one or more sub divisions in which the candidate object is determined to be present.

Point cloud representations of the domain, a sub division thereof, or of the candidate object, may be generated as preprocessing before the method of FIG. 4 is performed. Algorithms may be executed on either image data representations of the domain and/or candidate objects, or on 3D vector field representations thereof, in order to convert them to 3D point cloud representations for the processing illustrated in FIG. 4.

Any combination of line and plane will work for the translational alignment, as long as the line does not lie in the plane. In Cartesian coordinates, it may be that the xy plane is selected as the plane, and the z axis as the line. The line and plane may be selected to avoid lines and planes in which the projections show periodicity.

Two lines may be used as an alternative to the plane, in which case steps 5404 to 5406 are performed three times, once for each line. The three lines may be orthogonal. The three lines may be any mutually non-parallel selection of three lines that collectively have a component in each of three spatial dimensions.

The result of the method of FIG. 4 is a set of translations in the plane and lines (or along three lines) that can be converted into translations in the coordinate system of the image data providing the 3D representation of the domain, so that a representation of the candidate object from the object data database in a predetermined format can be placed in the image data at the correct position.

S401, 5402, 5404, 5405

The projection onto the line and/or plane is of every point in the cloud along a vector at an angle to the line, or along a curve. The angle of the vector of projection to the line and/or plane may be the same vector for all points in the cloud. Alternatively, the vector may be a function of position of the point, said function being consistent for both clouds of points. The projection may be along a curve onto the line. An example of this is for a cylinder to move all points around its circumference to lie on a line or alternatively to project radially onto the cylinder axis. Also, on a planetary scale or for another imaged spherical subject, it would make sense to project onto lines of latitude and longitude and onto the radius of the sphere. So that means the latitude and longitude lines are not straight and are actually circular lines.

The processing for finding the relative position of best match between the projections for the line/plane may be conducted as follows:

Slide the projection of one point cloud along the line or plane (onto which the image is projected) in small steps so that it begins to slide over and past the projection of the other image;

At each slide step calculate how well the two projections match by calculating a match which can be done in a number of ways listed below one of which is a mathematical correlation function. Note that this is a one/two dimensional correlation and so minimises the computational cost versus doing a three dimensional correlation;

For the line or plane, find the maximum value of the match between the projections and note the direction and distance one point cloud projection had to be moved along the line or plane in order to achieve this maximum matching value (it is noted that in the example of the plane the process to find the maximum value includes iterating through translations in both dimensions of the plane, so that whereas x iterations may be required for the line, x squared iterations are required for the plane);

Repeat for the other of the line/plane to obtain three translation distances (and direction along the line—positive or negative) which form the translation parts of a registration vector;

Depending on the size of the steps used when sliding the projections over one another, it may be that further alignment is required. For example, a coarse alignment could be found initially, with steps of size y, and then a region plus/minus y around the best match position a*y investigated with steps of, for example, one-tenth y, to find a best match position a*y plus minus b*y/10, wherein b is than 10. In the plane example, the same process can be followed, first finding a best match position a*y, c*x, then using smaller steps to find a best match position (a*y plus minus b*y/10, c*x plus minus d*x/10) wherein b, d, are less than 10;

The translation processing may include a fine alignment step using iterative closest point, ICP, or a least squares alignment algorithm. Convergence can be achieved using an error minimisation technique such as Levenberg-Marquardt (LM) algorithm. There are two versions of ICP that could be employed:

(a) Point to point ICP in which embodiments find the nearest point in the other dataset to a given point in the first dataset and calculate the RMS distance between them. Embodiments do this for every point. Then embodiments use a standard well known optimisation technique to minimise the sum of these RMS distances.

(b) Point to plane ICP in which embodiments find the nearest surface patch plane in the other dataset to a given point in the first dataset and calculate the RMS distance between them normal to the subplane. Embodiments do this for every point. Then embodiments use a standard well known optimisation technique to minimise the sum of these RMS distances.

The three obtained translation distances (along with information defining the line along which the distance is calculated) may be output. Alternatively or additionally, the output may be the obtained image data with the predetermined format data representation of the respective candidate object in the obtained image data rotated to the relative rotation giving the at least one maximum degree of match determined to indicate presence of the respective candidate object in the imaged domain, at a location determined by the recorded translations, replacing the co-located obtained image data.

### S403, S406

Finding a best match position of one- or two-dimensional projections can be done in a number of ways. For example:

mathematical correlation: a known mathematical operator which effectively slides one function over the other into all possible relative positions and integrates the product across the plane giving zero when there is no overlap. The calculated integrated value can then be also plotted on the plane as another function and the highest point indicates the best alignment. Figures such as d2min or normal distance between vectors can be used to quantify degree of match. If the object in the scene has a higher or lower point density than the object in the database of known objects, then the cross correlation of the two will be higher or lower than the autocorrelation of the object in the database with itself. This may be a problem if embodiments are using a fixed threshold, say 5%, less than the autocorrelation value so that when above this value it is recognised and when below it is not the object in the database. To overcome this problem, instead of straight cross correlation and straight autocorrelation embodiments may use instead normalised cross correlation and normalised autocorrelation. This means embodiments divide the Cross correlation of two functions by the square root of the product of the autocorrelations of each of the two functions separately. It also means embodiments divide the autocorrelation by itself always giving 1 as the expected value of correlation;

Embodiments may Fourier Transform in 2 dimensions such as elevation angle and azimuth angle, each of the 2 inputs. Then multiply and inverse Fourier Transform. Then find all of the peaks. Likewise for the projection onto the rod it is the same but just use a one dimensional Fourier transform and inverse Fourier Transform;

Local gain: one function is slid over the other function into all possible relative positions. Then a local area for 2D and local length for 1D, less than the area of length of the two functions is chosen and the two functions are summed and integrated within the area and divided by the integral of the stationary function to give the local gain or amplification of the function. If the two scans were taken from the same position at the same time and perfectly aligned then the local gain would be uniform and would take the value of 2. For partially overlapping perfectly aligned functions the gain will be higher in the overlap region approaching 2 and will be 1 elsewhere. The overlap region can therefore be extracted by setting two thresholds just above and just below 2 to select the region with values near 2. The sum will only be two if the two scans have similar point densities or have been normalised to be the same. However, the aim is to find the most uniform local gain across the overlap region. This uniformity of local gain can be found by calculation of the standard deviation or variance of local gain across the overlap region. Apart from exhaustive search of all relative positions of the two functions there are many well known search methods such as simulated annealing, genetic algorithms, direct gradient search to minimise a function such as variance of uniformity;

Potential energy: the two functions are plotted in 3D on the surface and are each represented by a rigid solid surface sheet. Then one function is slid over the other to all possible relative positions. In order to move one function over the other the lowest points on one function have to slide over the highest points on the other function. Let us assume one function is stationary and that we calculate the average height of the other function when placed onto of the stationary function to find the potential energy. The aim is to minimise the potential energy. Apart from exhaustive search of all relative positions of the two functions there are many well known search methods such as simulated annealing, genetic algorithms, direct gradient search to minimise a function such as potential energy. It is advantageous once complete to repeat this operation but swapping the two functions. The reason for this is that if someone came into the room in one scan but not the other the two scans would not have a low potential energy when aligned as the person would block them coming close enough if in the upper scan. However, once swapped the person has no effect on the potential energy. So the lowest potential energy between the two swaps is chosen as the alignment position;

Least squares or ICP: either of these known methods can be used, optionally after coarse alignment by mathematical correlation, local gain, or potential energy.

As an alternative translational alignment technique, the 3D vector field of the object can be 3D correlated with the 3D vector field of the domain once they have been rotated into the correct orientation according to the rotational translation giving the pertinent local maximum in S104. The correlation may be performed using the convolution theorem, by Fourier Transforming each, then multiplying then calculating the inverse Fourier Transform. A preprocessing step may involve converting the vectors into a 3D voxel form or point cloud form prior to Fourier transform.

### Further Information on Aspects of Embodiments

### More Information Regarding Object Data Database

Prior to step S101, the object data database may be created and populated.

The object data in the database library may be supplied by users or obtained from publicly available sources or obtained from internet searches. Additionally, there are known techniques which can convert a collection of 2D photographs of a 3D scene recorded from different positions and orientations into a 3D dataset of the scene. These may be used on all publicly available photographs of objects on the internet and from databases to recreate the 3D scenes and then to segment and extract objects. Objects will be extracted from the 3D scenes in both manual and automatic ways.

Manual Object Extraction: After scanning a 3D scene and aligning and joining the scans, objects of interest can be manually cut out of the scene and supplied to the database.

Automatic Object Extraction: The 3D scene is segmented which involves recognition of planes and removal of points associated with them. Followed by clustering of points and identification of clusters a certain distance from other clusters. Each cluster can be considered to be an “object” in terms of the database although it may in fact consist of several actual objects. So, these are subdivided into their component objects by object recognition according to steps S101 to S105.

It may be that there are plural instances of an object rotated to the same orientation. In such scenarios, a cross-correlation value plural times that for a single instance of the object may be generated. A first approach for handling such scenarios is to use multiple thresholds to look for n times the expected cross-correlation value. A second, alternative, approach is to store in the object data database a compound object of one, two, three, or n instances of the object similarly oriented.

Typical relative alignments of different types of object may be recorded to aid recognition. So, office chairs are generally near desks or partially under desks and near filing cabinets or computer monitors.

The naming or labelling of each type of object may be achieved using already named publicly available databases of named objects and from labelled user data. The database may also include multiple 2D projections of each 3D objects so that internet searches can be carried out on the 2D projection images to find names These will be automated semantic searches continuously carried out on new unnamed objects. Names may be, for example, manufacture name and model number, to be stored as metadata in the object data database entry of an object.

However, for unnamed objects with similarities in terms of degrees of match of the feature vectors to other objects in the database a suggested name can be given but this may require a person to intervene (manually confirm).

For unnamed objects without any similarity in terms of degrees of match of the feature vectors to any already in the database, a person may be required to identify and name the objects. These objects are newly-added to the object data database as new date entries. Each entry relates to a single object. The entry may comprise one or more from among, for example, a name of the object (provided manually as a user input), model number, manufacturer information, a representation of the object as an object 3D vector field, a representation of the object as a point cloud, and a representation of the object in a predetermined format (this may be provided, for example, by a manufacturer, with the database and its management software operable either to retrieve the predetermined format representation and add it to the data entry in an automated manner or to add a predetermined format representation obtained manually by a user and uploaded to the object data database). In this manner, any object of interest or group of features from the domain 3D vector field that is compared with candidate objects from the object data database but for which no match is found (i.e. there is an object in the domain that is unknown in the object data database) becomes the basis of a new data entry. Manual input may be utilised in the extraction of objects from the domain 3D vector field (that is, in the identification of physical features that together form an identifiable object).

The database library includes multiple different types of object in multiple different types of formats including one or more from among:

Point cloud formats rdbx, ptx, e57, fls, pts, zfs, xyz, ply, las, laz, res

Voxel

Mesh

CAD Industry Foundation Classes (IFC) BIM models

CAD from building design architects' software

Each object in each format also has a feature vector model calculated and stored with it and may additionally have several transforms calculated and stored with it. The transforms may include one or more from among:

Fourier,

Wavelet

Radial Basis Function

Radon

Mellin

Hough

### Database Population

Embodiments may process image data submitted by users to find objects not already in the database and these may be encoded in vector format and additionally stored in the object data database as new objects.

The vector models are stored in the object data database for comparison and correlation for recognition, localisation and orientation of those objects in new 3D scenes. The vector models can easily be matched to each other and this can quickly be done in Fourier space so all occurrences of an object model in a 3D scene can be found. The degree of correlation can be found by vector matching, but it is also helpful to quantify this as the amount of surface of the object which matches another object as a percentage of its total surface area or at least surface area likely to have been scanned.

In the vector model (3D vector field) both point features and other shape features are represented by vectors which have a direction and length and also associated attribute values. The features include those which might easily be extracted from and recognised and matched in one 3D representation such as a point cloud.

Embodiments may carry out mesh model to vector model conversion. First, the mesh model is converted to a point cloud. The point cloud is then converted to the 3D vector field (as detailed elsewhere in this document).

Embodiments may carry out Industry Foundation Classes (IFC) model to vector model conversion. Some ways to convert IFC model to Vector model might be to first convert the IFC model to point cloud or mesh and then convert to Vector model as described above.

For example, random points can be distributed with a uniform density across all surfaces. Alternatively, the program Blendsor can be used to simulate a laser scanner within or outside of an IFC defined room or building and will generate a point cloud for each scanner position.

Once the point clouds have been found the methods described for converting point clouds to vector models are used to find the Vector model.

Embodiments may carry out 2D Photographs to a Point Cloud Model to Vector Model Conversion. A series of photographs of a 3D scene taken from different viewpoints and overlapping each other sufficiently can be converted into a point cloud by software such as Metashape. The photographs can either be taken by the same camera or by a collection of cameras. So, embodiments may search the internet for collections of photographs of the same object and then combine them to make a point cloud which can then be segmented into objects and represented as object vector models in the object data database.

Once the point clouds have been found the methods described for converting point clouds to vector models are used to find the Vector model.

Embodiments may carry out voxel model to vector model conversion. The Voxel model splits the 3D space into boxes which are usually cubes using a square 3D grid. If the voxels are small compared to the average spacing of points in the point cloud, then the value place in each voxel may be 1 if there are any points in that box or 0 if there are no points in that box.

The centre of each voxel containing any points may be considered to be a new point cloud on a regular grid. So, the methods for converting point clouds to vector models can be used to find the vector model. In the case of the large voxels the numerical value at the centre of each voxel can be used as a weighting factor to influence the degree of importance of that voxel in the calculation of the RMS weighted error from a primitive shape.

### Filter

As an optional processing step, a non-linear filter can be applied to the sets of vectors, or to the image data (e.g. point clouds), in which edges, planes, cylinders, tori, cones, spheres and other shapes are identified and the points or vectors associated with them are preserved for further processing while the rest are removed. The choice of such features depends on the 3D scene, so for buildings edges and planes may be beneficial. If the imaging apparatus is very noisy and the scene is known to contain certain complex features it can be beneficial to find those features by fitting known shapes to reduce the scatter of points due to noise. Another method is to use autoencoder neural networks to learn the basic 3D features, which is basically a neural network weighted interconnection layer which has been trained with the same data presented at both the input and the output. Then we can extract those features from the weights of the interconnects by the methods of Selviah, D. R., J. E. Midwinter, A. W. Rivers, and K. W. Lung. “Correlating matched-filter model for analysis and optimisation of neural networks.” In IEE Proceedings F (Radar and Signal Processing), vol. 136, no. 3, pp. 143-148. IET Digital Library, 1989.

Then the points can be projected along the nearest surface normal onto the complex feature. If only the edges are recognised and extracted this will save a lot of memory and calculation cost. This may be possible for some scenes having clear edges. This effectively amounts to alignment of a wire frame version of the 3D scene. This non-linear filter can be applied to the point cloud or to the set of vectors, whichever is the most convenient for the pattern recognition algorithm. As a further alternative, in embodiments in which the comparing processing of step S104includes forming a sphere of the set of vectors by assigning them a common origin, the non-linear filter may be applied to the sphere (which may be a Gaussian sphere). For example, in the Gaussian sphere representation it is known that points of high point density on the Gaussian sphere are due to planes in the scene, Great circles and nearby points are due to cylindrical objects in the scene, Non-great circles and nearby points are due to conical objects or partially conical objects. Therefore, this method makes use of all such objects to establish rotational alignment as well as other objects. Therefore, it is possible to selectively enhance planes or cylinders or cones before rotational alignment.

In order to recognise complex shapes like chairs an artificial intelligence algorithm such as Deep Learning can be trained using a sufficiently large dataset of example chairs and then used to recognise chairs. This method sometimes requires segmentation to be carried out first before Deep learning recognition. One example, is the Dynamic Graph Convolutional Neural Network (DGCNN) trained using the Stanford Large-Scale 3D Indoor Spaces Dataset (S3DIS) of seventy thousand 3D objects of 13 types, structural objects: ceiling, floor, wall, beam, column, window, door, and movable objects: table, chair, sofa, bookcase, board and clutter in 11 types of room. This CNN segments at the same time as recognising objects. More information can be found in Wang, Yue, Yongbin Sun, Ziwei Liu, Sanjay E. Sarma, Michael M. Bronstein, and Justin M. Solomon. “Dynamic graph CNN for learning on point clouds.” ACM Transactions on Graphics (TOG) 38, no. 5 (2019): 1-12.

Zhang, Kuangen, Ming Hao, Jing Wang, Clarence W. de Silva, and Chenglong Fu. “Linked dynamic graph CNN: Learning on point cloud via linking hierarchical features.” arXiv preprint arXiv:1904.10014 (2019).

### Edge Detection Algorithms

The non-linear filter may comprise executing an edge detection algorithm, and excluding from further processing any data point (in the point cloud) or vector (in the set of vectors) not representing an edge. Examples of edge detection algorithms include BAO algorithms, RANSAC line detection algorithms (for example, either directly by fitting straight lines to edges using RANSAC or by first finding planes by RANSAC or Hough Transform plane detection and then finding the edges of those planes), or a trilinear interpolation algorithm.

FIGS. 6-12 of International patent publication WO2018/138516 illustrate exemplary edge detection techniques. Further detail is in Annex C of United Kingdom patent publication 2559157.

### Feature Vectors

Embodiments may use plural different types of vector with associated attribute parameters each calculated in different ways and at different levels of scale and complexity to represent the candidate objects and the domain with 3D vector fields.

Information derived from the initial image data representing the domain or the candidate object may be in the form of features which are identified in an automated manner. Features are recognised automatically and repeatedly, and each feature is represented by a feature vector. A 3D vector field only includes vectors of a particular type, for example, divergence vectors or cylinder vectors, but not both.

The feature and its position and orientation, and optionally also its associated attribute values (for example, colour, reflectivity, surface roughness) distinguish one object from another object which either may not have that feature or may not have it with the same relative orientation and associated attribute values. Relative position and relative orientation mean the position and orientation relative to other features of the same or different types within the same workspace or co-ordinate space or frame of reference.

Every identifiable feature at every level of size and scale and every distinguishable aspect of a 3D object and of a 3D environment may be marked in position and orientation and quantified. These features may be of a range of dimensions from points, OD; lines or edges, 1D; planes, 2D; corners, 3D; trajectories and variation of speed through those trajectories, 4D. The higher dimensional features may be fundamental features or may be made up of lower order features. So, the corner of a room will consist of 3 planes at particular relative orientations and three edges at particular relative orientations. Embodiments may not only use the three plane vectors (vector type being plane vector) and the three edge vectors (vector type being edge vector) to represent the object, but also additionally a specific corner vector (vector type being corner vector).

If the feature has some directionality about it then it is marked by a vector placed at the location of that feature pointing in a direction showing the orientation of that feature. For example if the feature is a 3D feature and if it can only be oriented in one direction to match the orientation of that feature in the object or scene then that feature is represented by a vector which is a line or arrow with its tail located at, for example, the centre of mass (or another point within the feature) of the feature and the tip of the arrow pointing in a direction which can be repeatably found and not mistaken for any other direction in that feature.

In embodiments in which the domain is a building, information derived from the image data may be surface normals at every point (if the building is represented by a point cloud). A vector field composed of vectors representing the surface normal is generated and stored as a domain 3D vector field. Then embodiments may find the planes and represent each plane by a vector pointing normal to the plane centred at the centre of mass of the plane with a length equal to the area of the plane. In this manner, a further domain 3D vector field composed of plane vectors is generated. However, the shape of the plane and where the holes are in it may also be encoded and associated with that vector. That means embodiments may also representing absences of parts of a plane as vectors within the same vector field as the plane vectors (i.e. of the same type). In addition, the colour, surface texture, surface roughness, surface furriness can be quantified as associated attribute values and associated with the plane vector.

For example, sum vectors may then be found, which lie generally in the plane and point away from edges at right angles to them and are longest near edges.

Then the edges where two planes would be found and represented by a vector lying along that edge, with a length equal to the length of the edge. In this case there is some ambiguity as to which direction along the edge the vector should point so embodiments define a feature to vector transform to avoid this confusion. For example, vectors may point up or if exactly horizontal to the East. Associated attribute values may include the radius of curvature of the edge, and/or the position and orientation of the two planes either side of the edge which intersect to form the edge.

Corners are found where three edge vectors intersect. Then each corner can be represented by a single vector pointing at equal angles to the three edges while minimising these angles, for example.

Then cylinders and partial cylinders can be found and represented by a vector along the axis at the location of the cylinder. The length could be equal to the length of the cylinder, but the radius of the cylinder would also be associated with this vector as an attribute. In addition, the colour, surface texture, surface roughness can be quantified as attribute values and associated with the cylinder vector.

A circular hole or lip of a mug or partial circle can be recognised and then represented by a vector normal to the circle plane at the centre of the circle with a length equal to the radius of the circle. Associated attribute parameters include the radius of curvature of the edge. Holes in walls or in planes or in cylinders or other objects or a gap in an edge can be represented by vectors. The hole can be a doorway or even a window as the glass reflects very few laser beams back so there are few points on the glass of the window. Or the arrangement of 3 holes in an electrical plug socket can be represented by a vector.

International patent publication WO2018/138516 provides further detail on the processing steps for converting point cloud image data to vector fields of different vector types, in particular at FIGS. 8 to 12 and in the description at page 46, line 25, to page 58, line 2. The processing steps set out in that section may be utilised in embodiments of the present invention to convert the image data representing the domain and/or image data representing the candidate objects to vector fields, noting that preprocessing may be required to convert said image data to point cloud data.

More feature vectors represent spheres, ellipsoids, tori, cones, frustums, pyramids, quadrics, edges with various radii of curvature. The edge of the path around a lawn can be recognised and found by the colour and roughness change and represented by surface normals (or sum vectors) pointing normal to the edge away from the grass and for very straight edges by edge vectors along the edge.

The maximum and minimum curvature at each point on a surface can be found and the orientations of their tangents to the surface can be found. So, the maximum curvature is in one direction and the minimum curvature in another direction. These can then be converted into maximum and minimum curvature vector distributions where the vector direction shows the direction of maximum or minimum curvature as a tangent to the surface and the length of the vector is the value or maximum or minimum curvature. These two distributions uniquely describe and identify the surface shape of the object. Of course, adding associated attribute values such as colour, reflectivity, surface texture, surface roughness, surface furriness will more accurately help distinguish one such object from another similar object. Embodiments may project a point density distribution onto a plane and rod for translation alignment. However, the surface curvature vector magnitudes for max and min curvatures could instead be projected onto a plane or a rod for each surface and used for alignment and recognition.

Embodiments may enlist neural networks and autoencoders to automatically classify features into various types which can distinguish between different classes of objects in a set. Optionally, the features can also be represented by vectors. The following references demonstrate that neural networks can be used to automatically extract features or internal representations and are just arrays of correlators for correlating different types of feature and so perform the functionality that is required.

Selviah, D. R., J. E. Midwinter, A. W. Rivers, and K. W. Lung. “Correlating matched-filter model for analysis and optimisation of neural networks.” In IEE Proceedings F (Radar and Signal Processing), vol. 136, no. 3, pp. 143-148. IET Digital Library, 1989.

Selviah, D. R., and J. E. Midwinter. “Extension of the Hamming neural network to a multilayer architecture for optical implementation.” In 1989 First IEE International Conference on Artificial Neural Networks, (Conf. Publ. No. 313), pp. 280-283. IET, 1989.

Selviah, D. R., and J. E. Midwinter. “Memory Capacity of a novel optical neural net architecture.” ONERA-CERT, 1989.

Selviah, David R., and Epaminondas Stamos. “Similarity suppression algorithm for designing pattern discrimination filters.” Asian Journal of Physics 11, no. 2 (2002): 367-389.

Selviah, David R. “High speed optical higher order neural networks for discovering data trends and patterns in very large databases.” In Artificial Higher Order Neural Networks for Economics and Business, pp. 442-465. IGI Global, 2009.

When correlations are calculated at S104, each type of vector is only matched with vectors of its own type. In addition, if the correlation takes into account associated attribute value, the attribute values associated with each vector are only matched with attribute values representing the same parameter, so colour with colour. The magnitudes of these correlations or degrees of match then indicate whether one object matches another in a 3D environment. Ideally all of the correlations of each type of vector will be maximised or above some threshold. However, it may be that the object is damaged, deformed, dented, dirty, repainted or a different size so we note which correlations are not as high as we expect and output this to the user to inform them what is similar and what is different about the object found and the reference ones in our database.

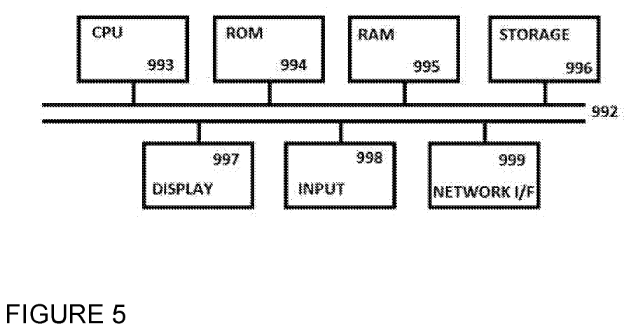

### FIG. 5

FIG. 5 is a block diagram of a computing device, such as a server, which embodies the present invention, and which may be used to implement a method of any of the embodiments. In particular, the computing device of FIG. 5 may be the hardware configuration of one or more servers or computers in a cluster of computers such as a data centre, providing the method of an embodiment as a service to clients (users) operating computing devices in data communication with the server or servers. The computing device of FIG. 5 may be used to implement the method of any or all of FIGS. 1 to 4. A plurality of computing devices such as that illustrated in FIG. 5, operating in cooperation with one another, may be used to implement the method of any or all of FIGS. 1 to 4.

The computing device comprises a computer processing unit (CPU) 993, memory, such as Random Access Memory (RAM) 995, and storage, such as a hard disk, 996. Optionally, the computing device also includes a network interface 999 for communication with other such computing devices of embodiments. For example, an embodiment may be composed of a network of such computing devices operating as a cloud computing cluster. Optionally, the computing device also includes Read Only Memory 994, one or more input mechanisms such as keyboard and mouse 998, and a display unit such as one or more monitors 997. The components are connectable to one another via a bus 992.

The CPU 993 is configured to control the computing device and execute processing operations. The RAM 995 stores data being read and written by the CPU 993. In addition, there may be a GPU. The storage unit 996 may be, for example, a non-volatile storage unit, and is configured to store data. A single CPU is illustrated. However, embodiments may be implemented by a computing apparatus having, or having access to, a plurality of processors each having dedicated memory and configured to carry out parallel processing operations. For example, in order to implement the method of FIG. 3.

The optional display unit 997 displays a representation of data stored by the computing device and displays a cursor and dialog boxes and screens enabling interaction between a user and the programs and data stored on the computing device. The input mechanisms 998 enable a user to input data and instructions to the computing device. The display could be a mobile phone, mobile tablet, or laptop, 3D display using stereo glasses or all in a helmet like Hololens or a holographic display or an autostereoscopic display neither of which need special glasses.

The network interface (network I/F) 999 is connected to a network, such as the Internet, and is connectable to other such computing devices via the network. The network I/F 999 controls data input/output from/to other apparatus via the network. The network I/F may provide a connection to a computing device from which the 3D datasets were obtained, and may receive arguments or instructions defining elements of the processing (for example, selecting algorithms) For example, a user device such as a computer may submit image data providing a 3D representation of a domain to the computing device (of FIG. 5) implementing an embodiment via the network interface 999. The method is performed by the computing device of FIG. 5, and the augmented 3D image data (or a hyperlink to a location from which the user may, subject to authentication, access the augmented 3D image data) returned to the user device via the network interface 999.

Other peripheral devices such as microphone, speakers, printer, power supply unit, fan, case, scanner, trackerball etc may be included in the computing device.

An image processing apparatus or device of an embodiment may be one or more computing devices having a processor and a memory, the memory configured to store processing instructions which, when executed by a processor, cause the processor to perform a method of an embodiment. The processing instructions may be provided by a computer program, which may be stored on a storage medium such as a non-transitory storage medium. One or more of said computing devices may be a computing device such as that illustrated in FIG. 5. One or more such computing devices may be used to execute a computer program of an embodiment. Computing devices embodying or used for implementing embodiments need not have every component illustrated in FIG. 5, and may be composed of a subset of those components. A method embodying the present invention may be carried out by a single computing device in communication with one or more data storage servers via a network.

1. An image processing method comprising:
obtaining image data, the image data comprising readings providing a 3D representation of a domain;
converting the image data to a domain 3D vector field consisting of vectors representing the readings as vectors by deriving information from the readings in the image data and using a defined information-to-vector transform to convert the derived information into vectors, each of the vectors being positioned in the domain 3D vector field in accordance with positions of the readings represented by the respective vector in the image data;
access an object data database wherein each of a plurality of candidate objects is, in a first representation, stored in a predetermined format and/or stored as object metadata, and in a second representation, stored as an object 3D vector field having been derived from a transform corresponding to the defined information-to-vector transform;
compare the domain 3D vector field with the object 3D vector field;
wherein the comparing comprises finding at least one maximum, by relative rotation of the vectors of the domain 3D vector field with respect to the vectors of the object 3D vector field with the vectors positioned at a common origin, of a degree of match between the vectors of the domain 3D vector field and the vectors of the object 3D vector field,
for the or each of the at least one maximum, based on the degree of match, determining whether or not the respective candidate object is present in the physical imaged domain, and
for instances in which it is determined that the respective candidate object is present in the imaged domain:
placing the predetermined format data representation of the respective candidate object in the obtained image data at an orientation determined by the relative rotation of the two sets of vectors providing the at least one maximum degree of match; and/or
annotating the obtained image data with the metadata of the candidate object determined to be present in the imaged domain.

2. The method according to claim 1, wherein the domain 3D vector field comprises a plurality of sub-fields, and the comparing comprises comparing each of the plurality of sub-fields with the object 3D vector field of each of the plurality of candidate objects;
wherein the comparing includes dividing the 3D representation of the domain into a plurality of sub-divisions, and each sub-field corresponds to a respective one of the sub-divisions;
or wherein the sub fields are individual or groups of features extracted from the domain 3D vector field by a segmentation algorithm.

3. The method according to claim 2, wherein each of the plurality of sub fields is assigned to a distinct processor apparatus, and the plurality of sub fields are compared in parallel with the object 3D vector fields of each of the plurality of candidate objects on their respectively assigned distinct processor apparatus; or
wherein the plurality of candidate objects are divided into a plurality of classes of object, and each class of object is assigned to a distinct processor apparatus and compared with each of the plurality of sub fields on the assigned processor apparatus; or
wherein the plurality of candidate objects are divided into a plurality of classes of object, and each combination of class of object from the plurality of classes of object and sub field from the plurality of sub fields is assigned to a distinct processor apparatus, and the comparison between candidate objects from the respective class of object with the respective sub field is performed on the respectively assigned processor apparatus.

4. The method according to claim 2, wherein if one of the candidate objects is determined to be in the imaged domain based on comparing of one of the plurality of sub-fields with the object 3D vector field of said one of the candidate objects,
the plurality of candidate objects for each of the other sub-fields among the plurality of sub-fields is constrained to a subset of the plurality of candidate objects, the subset having fewer members than the plurality of candidate objects, and being selected based on the said one of the candidate objects determined to be in the imaged domain.

5. The method according to claim 1, wherein the plurality of candidate objects are divided into a plurality of classes of object, and wherein, if it is determined that a candidate object is present in the imaged domain and is belonging to a particular class of the plurality of object classes, then then the method further comprises:
storing, in the object model database, only those candidate objects belonging to the particular class.

6. The method according to claim 1, wherein the information derived from the readings is information representing the whole or part of physical features represented by readings in the image data resulting from one or more of the lines or edges, surface or interface, surface roughness, reflectivity, curvature, contours, colours, shape, texture, planes, corners, cylinders, tori, saddle point surfaces, ogive surfaces, quadric surfaces, material density, material absorption and/or materials of the physical feature itself and/or its ornamentation, wherein the physical feature may be a hole or gap in a plane or another physical feature, or an arrangement of multiple holes or gaps; and wherein
the said information derived from the readings is represented by a vector or vectors in the domain 3D vector field and/or stored in association with a vector of the domain 3D vector field as an associated attribute.

7. The method according to claim 1 wherein, the plurality of candidate objects is a subset of the population of objects stored in the database, each object among the population of objects being stored in association with a classification, the classification indicating one or more object classes to which the object belongs, from among a predetermined list of object classes;
the method further comprising determining the plurality of candidate objects by:
inputting to a classification algorithm the image data or the domain 3D vector field, the classification algorithm being configured to recognise one or more classes of objects to which objects represented in the input belong;
the plurality of candidate objects being those stored in the database as belonging to any of the one or more recognised classes of object.

8. The method according to claim 1, wherein the at least one maximum is a plurality of local maxima, and the determining whether or not the respective candidate object is present in the imaged domain is performed for each local maximum in order to determine a minimum number of instances of the respective candidate object in the imaged domain;
wherein either the placing or annotating is performed for each of the minimum number of instances of the respective candidate object determined to be in the imaged domain.

9. The method according to claim 1, wherein
the defined information-to-vector transform is one of a set of plural defined information-to-vector transforms, each to convert respective information derived from the readings in the image data into vectors of a respective vector type, each of the vectors being positioned in the 3D vector field in accordance with positions of the readings represented by the respective vector in the image data;
the converting comprising, for each member of the set of plural defined information-to-vector transforms, deriving the respective information from the readings in the image data and using the defined information-to-vector transform to convert the derived information into a domain 3D vector field of vectors of the respective vector type, each of the vectors being positioned in the 3D vector field in accordance with positions of the readings represented by the respective vector in the image data;
each of the plurality of candidate objects is stored as a plurality of object 3D vector fields in the object data database, the plurality of object 3D vector fields comprising one object 3D vector field derived from a transform corresponding to each member of the set of plural defined information-to-vector transforms and thus representing the respective candidate object in vectors of the same vector types as the vector types of the corresponding domain 3D vector field into which said member transforms information derived from readings in the image data;
the comparing is performed for each pair of domain 3D vector field with its corresponding object 3D vector field of vectors of the same vector type, and
determining whether or not the respective candidate object is present in the imaged domain is based on a weighted average of the degrees of match of the at least one maximum for one or more of the pairs in a case where more than one vector type has a maximum; or, in a case where only one vector type has a maximum, based on that maximum for the vector type.

10. The method according to claim 1, wherein the predetermined format in which the first representation of each of the plurality of candidate objects is stored is a data format encoding information about the appearance of the candidate object and material properties of the candidate object, which material properties include labelling entities within the candidate object as being formed of an identified material, wherein said data format may be CAD data, and optionally wherein the predetermined format is a mesh format, a voxel format, Industry Foundation Classes (IFC) format, DWG format, or a DXF format.

11. The method according to claim 1, wherein the degree of match between the vectors of the domain 3D vector field and the vectors of the object 3D vector field is quantified by calculating a mathematical correlation between the vectors of the domain 3D vector field and the vectors of the object 3D vector field as the degree of match.

12. The method according to claim 2, further comprising
using an object 3D element field representing the or each candidate object determined to be in the imaged domain, and a domain 3D element field representing a relevant portion of the domain, to find a translational alignment of the candidate object within the relevant portion of the domain, wherein the relevant portion is the portion corresponding to the sub-field of the domain 3D vector field in which the respective candidate object is determined to be in a case in which the domain 3D vector field is divided into sub fields for the comparing, and wherein the relevant portion is the entire domain 3D vector field otherwise,
wherein the object 3D element field and the domain 3D element field are either 3D vector fields, with each element in the object and domain 3D element fields being a vector from the respective 3D vector field, or 3D point clouds, with each element in the object and domain 3D element fields being a point from the respective 3D point cloud, and in the case of 3D point clouds:
the method includes obtaining the domain 3D vector field as a 3D point cloud, being the domain 3D element field, or each sub-field of the domain 3D vector field as a 3D point cloud, being the domain 3D element field, and obtaining the object 3D vector field of the or each candidate object determined to be in the imaged domain, rotated to the relative rotation giving the at least one maximum degree of match determined to indicate presence of the respective candidate object in the imaged domain, as a 3D point cloud, being the respective object 3D element field;
and in the case of 3D vector fields:
the domain 3D element field is the relevant portion of the domain 3D vector field, and the object 3D element field is the object 3D vector field of the respective candidate object determined to be in the imaged domain, rotated to the relative rotation giving the at least one maximum degree of match determined to indicate presence of the respective candidate object in the imaged domain.

13. The method according to claim 12, the method further comprising, for the or each candidate object determined to be in the imaged domain:
for a line and a plane in a coordinates system applied to the 3D representation of the domain provided by the image data, wherein the line is at an angle to or normal to the plane:
record the position, relative to an arbitrary origin, of a projection onto the line of each element among the domain 3D element field, and store the elements in the recorded positions as a domain 1-dimensional array, and/or store a point or one or more properties or readings of each element at the respective recorded position as the domain 1-dimensional array;
record the position, relative to an arbitrary origin, of a projection onto the plane of each element among the domain 3D element field, and store the elements in the recorded positions as a domain 2-dimensional array, and/or store a point or one or more properties or readings of each element at the respective recorded position as the domain 2-dimensional array;
record the position, relative to the arbitrary origin, of the projection onto the line of each element among the rotated object 3D element field, and store the recorded positions as an object 1-dimensional array, and/or store the said point or one or more properties or readings of each element at the respective recorded position as the object 1-dimensional array;
record the position, relative to an arbitrary origin, of a projection onto the plane of each element among the rotated object 3D element field, and store the recorded positions as an object 2-dimensional array, and/or store the said point one or more properties or readings of each element at the respective recorded position as the object 2-dimensional array;
find a translation along the line of the object 1-dimensional array relative to the domain 1-dimensional array at which a greatest degree of matching between the domain 1-dimensional array and the object 1-dimensional array is computed, and record the translation at which the greatest degree of matching is computed; and
find a translation, in the plane, of the object 2-dimensional array relative to the domain 2-dimensional array at which a greatest degree of matching between the domain 2-dimensional array and the object 2-dimentional array is computed, and record said translation;
output either:
a vector representation of the recorded translation along the line and in the plane;
the obtained image data annotated to indicate the presence of the respective candidate object in the imaged domain, at a location determined by the recorded translations; and/or
the obtained image data with the predetermined format data representation of the respective candidate object in the obtained image data rotated to the relative rotation giving the at least one maximum degree of match determined to indicate presence of the respective candidate object in the imaged domain, at a location determined by the recorded translations, replacing the co-located obtained image data.

14. The method according to claim 13, wherein, in the case of the elements of the object 3D element field and the domain 3D element fields being vectors, the degree of match between the domain 2-dimensional array and the object 2-dimensional array, and/or between the domain 1-dimensional array and the object 1-dimensional array, is quantified by, for each vector in a first of the two respective arrays, calculating a distance to a closest vector or a closest matching vector in the other of the two respective arrays, said closest matching vector having a matching magnitude and direction to the respective vector to within predefined thresholds, and summing the calculated distances across all vectors in the first of the two respective arrays, including adding a predefined value to the sum if no closest matching vector is found within a predefined maximum distance.

15. The method according to claim 12, including finding a scale of the or each candidate object determined to be in the imaged domain by finding a maximum correlation of a scale variant transform applied to the respective object 3D vector field and a relevant portion of the domain 3D vector field, and scaling the respective object 3D vector field in accordance with the scale giving maximum correlation.

16. The method according to claim 1, wherein the object metadata is an identification of a name, and/or a manufacturer and model number, of the candidate object.

17. A computing apparatus comprising at least one processor and a memory, the memory configured to store processing instructions which, when executed by the at least one processor, cause the at least one processor to perform the method of claim 1.

18. A computer program comprising processing instructions which, when executed by a computing device comprising a memory and at least one processor, cause the at least one processor to perform the method according to claim 1.
